(19) United States
(12) Patent Application Publication
(10) Pub. No.: US 2024/0421419 A1
(43) Pub. Date: Dec. 19, 2024

(54) Battery Systems with Pouch Cells

(71) Applicant: Cadenza Innovation, Inc., Danbury, CT (US)

(72) Inventors: Tord Per Jens Onnerud, Wilton, CT (US); Jay Jie Shi, Acton, MA (US); Richard V. Chamberlain, II, Fairfax Station, VA (US)

(73) Assignee: Cadenza Innovation, Inc., Danbury, CT (US)

(21) Appl. No.: 18/701,811

(22) PCT Filed: Oct. 18, 2022
(86) PCT No.: PCT/US2022/046994

§ 371 Date: Apr. 16, 2024

Related U.S. Application Data
(60) Provisional application No. 63/257,395, filed on Oct. 19, 2021.

(51) Int. Cl. H01M 50/342; H01M 50/211; H01M 50/289; H01M 50/367; H01M 50/383

(52) U.S. Cl. CPC H01M 50/3425; H01M 50/211; H01M 50/289; H01M 50/367; H01M 50/383

(57) ABSTRACT

Battery systems are provided that include polymer cells/pouch cells. The polymer cells/pouch cells are structured such that, in response to an increase in pressure within the polymer/pouch cell, e.g., a pressure increase beyond a threshold level, the polymer/pouch releases gasses in a directionally controlled manner so as to facilitate withdrawal of the gasses from the battery enclosure through a vent structure that is positioned for ease of communication with the released gasses. The battery enclosure is generally sealed, e.g., hermetically sealed, and the polymer cells/pouch cells may be spaced from each other, e.g., by a support structure that may include interleaved barrier structures.

### CROSS-REFERENCE TO RELATED APPLICATION

The present application claims the benefit of priority to United States Provisional Patent Application No. 63/257,395 filed on Oct. 19, 2021, which is incorporated herein by reference in its entirety.

### FIELD OF DISCLOSURE

This disclosure relates to battery systems that include polymer cells/pouch cells. The disclosed polymer cells/pouch cells are structured such that, in response to an increase in pressure within the polymer/pouch cell, e.g., a pressure increase beyond a threshold level, the polymer/pouch releases gasses in a directionally controlled manner so as to facilitate withdrawal of the gasses from the battery enclosure through a vent structure that is positioned for ease of communication with the released gasses. The battery enclosure is generally sealed, e.g., hermetically sealed, and the polymer cells/pouch cells may be spaced from each other, e.g., by a support structure that may include interleaved barrier structures. Individual cells inside such battery systems may be individually fused before being electrically connected to a common busbar terminal.

### BACKGROUND

Lithium ion battery systems are used in a wide array of applications, including energy storage for motive drive and energy storage for stationary systems. These battery systems have modules that incorporate a number of Li-ion cells of varying types, including small cylindrical cells, larger prismatic cells or polymer (or pouch) cells. The capacity and voltage of a system is controlled by connecting the cells in parallel and/or serially within a module. Larger systems have multiple modules, with similar serial or parallel connections. In order to optimize cost and performance, each serial element of a battery needs to have the same capacity in terms of Ah. Also each string of battery modules or cells in series used in a battery system needs to operate at the same relative voltage for optimal performance. Depending on the application, these batteries may further have additional mechanical requirements, such as geometrical format/form factor and an ability to be cooled by air or liquid cooling circuits.

In current practice, battery energy storage systems (BESS) are deployed to support the grid during times of high power utilization where local grid points cannot support the flow of energy to areas of high use, such as densely populated areas. In other areas, there is a desire to strengthen the grid to support a higher utilization of solar and wind, as well as hydropower. Cheaper than natural gas, coal and oil, energy from renewable sources can be stored in BESS during low power periods and deployed during high use. A third area of operation is in large motive systems, where hundreds of cells are operated in big battery arrays.

However, for all of these type of large battery systems, a fire risk has been identified in the field where propagating runaway and flammable gases have caused energy storage installations to experience fire and explosions. This risk may be attributed to two main causes:
1. Thermal runaway, sometimes with propagation; and
2. Exhaust of flammable/explosive gases and associated ignition, resulting in fires of explosive nature

Failure originating because of external shorts and overcharge may be mitigated by fuses and electronic protection. However, a majority of these catastrophic events originate from an internal short in the Li-ion cell, resulting in a cell experiencing thermal runaway and propagation to neighboring cells in the module. Module-to-module propagation then takes place and a cascading fire results that can spread to the entire battery rack and any neighboring battery rack. Even when one cell fails without propagation, the capacity of the one cell can be so high that the high amount of flammable gases ejected reaches its lower flammability limits and an explosion and fire is initiated that can trigger further fire propagation and additional explosions.

A BESS system is typically installed in an enclosure or dedicated building and consists of a number of battery racks that stores the energy, an inverter (which converts the DC voltage to AC voltage that can be connected to the power grid), and control systems that communicate between the battery racks, the inverter, and from inverter to the grid controls (such as a building management systems or a centrally managed dispatch). The risk of propagating runaway of densely packaged Li-ion batteries when an internal fire (usually from an internal short) takes places is a serious issue for widespread adoption and success of Li-ion grid storage systems. Similarly, for battery systems for motive power, such as electric vehicles, buses, boats, and trains, one or more electric motors are fed with the DC power from the battery systems, having large arrays of battery cells in sealed enclosures which can experience explosion, fire and propagation upon an internal short. The larger the cell capacity, the higher the risk that the lower flammability limits, and hence risk of explosion, are reached within the enclosed battery space.

Thus, a need exists for battery systems that, in response to an increase in pressure within a polymer/pouch cell, the battery system operates to eliminate, reduce and/or control the potential for a cascading failure within or by the battery system. The present disclosure effectively addresses the noted need in a cost effective and reliable manner.

### SUMMARY

The present disclosure provides battery systems that include, inter alia, a plurality of electrode assemblies consisting of solid polymer electrolytes, gel electrolyte or liquid electrolyte or electrode rolls where the pouch is not added to the system. These individual cell configurations are in the following referred to as polymer or pouch cells. The electrode assemblies in such polymer/pouch cells typically contains one of the following type of electrolytes; solid polymer electrolytes, gel electrolyte or liquid electrolyte. These electrode assemblies can be stand alone or contained in pouches in a polymer/pouch cell. Preferably, the solid polymer electrolyte electrode assemblies are in the stand-alone form, and the electrode assemblies with gel or liquid electrolytes are contained in pouches. When one or more electrode assemblies are located in a pouch, it is further preferred that the pouch is sealed. According to the present disclosure, the polymer cells/pouch cells are structured such that, in response to an increase in pressure within the polymer/pouch cell, e.g., a pressure increase beyond a threshold level, the polymer/pouch releases gasses in a directionally controlled manner so as to facilitate withdrawal of the gasses from the battery enclosure through a vent structure that is positioned for ease of communication with the released gasses.

Directional release of gasses from the polymer/pouch cell may be effectuated in various ways according to the present disclosure. For example, the polymer/pouch may include one or more score lines in the polymer/pouch structure that are configured and dimensioned to act as a predetermined point of failure if/when the pressure within the polymer/pouch rises, e.g., exceeds a threshold pressure level. Seam(s) associated with formation of the polymer/pouch may be weakened relative to the remainder of the polymer/pouch, e.g., through selection and/or application levels of the requisite adhesive or other modification to the sealing operation in a desired region for release of gasses upon pressure increase within the polymer/pouch, e.g., pressure increase above a threshold level.

The battery enclosure of the present disclosure is generally sealed, preferably hermetically sealed, and the polymer cells/pouch cells are positioned within and generally spaced from each other by interleaved barrier structures, e.g., ceramic cell barriers. The barrier structure prevents the sharing of electrolyte between each one of the individual polymer cells, which are typically connected in parallel. Such polymer cells may also be connected in series within the enclosure. For polymer cells contacted in parallel, a common busbar is used, one for the positive polymer cell electrodes and another negative busbar for the negative electrodes. Each of the negative electrodes may further be fused, so that upon an internal short, the fusing mechanism disallows the current from a parallel cell to feed energy to a failing cell.

One or more of the interleaved barrier structures may include surface features that guide gasses that are released from a compromised polymer cell/pouch to a desired exit region. Thus, the barrier structures may define gas flow paths, e.g., based on molded features or the like. Furthermore, the barrier structure prevents heat transfer between electrode assemblies. In the case of one electrode assembly has internal short circuit, the heat generated in this electrode assembly is prevented to transferring to neighboring electrode assemblies through direct thermal conduction.

Exemplary implementation of the disclosed battery system include implementations wherein:
the sealed battery enclosure of the battery system includes a pressure-activated vent and, in certain instances, the pressure-activated vent is equipped with a flame arrestor; the pressure-activated vent is generally activated at a pressure below about 100-300 psi and/or the battery is configured such that, when activated, gas is released from the battery enclosure to reduce the potential for a cascading failure therewithin.
the interleaved barrier structures may be integrally formed (in whole or in part) so as to define a support structure for the polymer cells/pouches that are introduced therebetween; alternatively, rather than integral formation of the noted support structure, the interleaved barrier structures may be adapted to attachment relative to a base member such that, when attached, the base member and interleaved barrier structures define a support member for the polymer cells/pouches.
the interleaved barrier structures may be fabricated, in whole or in part, from one or more endothermic materials; alternatively, endothermic materials may be associated with the interleaved barrier structures and/or the support member that includes the interleaved barrier structures. An exemplary endothermic material for use according to the present disclosure is alumina trihydroxide.
the interleaved barrier structures may be fabricated, in whole or in part, from a a silicate-based ceramic material, a metal oxide and/or mineral wool, polymer materials.
the collective thickness (in mm) of the interleaved barrier structures may be equal to or larger than about 1% of the energy density of the polymer cells/pouches measured as Wh/kg.
if cells having no external pouch are used, the separating structures or interleaved barrier structure disallows the effective sharing of electrolyte between the individual cells in such a way that if one cell fails, no propagation happens between the individual cells. The fusing mechanism will in such cases disallow thermal energy to build up in the failed cells due to continuous current dumping from the non-shorted neighboring cells.

The present disclosure also provides a method for implementation of the disclosed battery systems.

Additional features, functions and benefits of the disclosed battery systems will be apparent from the description which follows, particularly when read in conjunction with the accompanying figures.

### BRIEF DESCRIPTION OF THE FIGURES

To assist those of skill in the art in making and using the disclosed assemblies, systems and methods, reference is made to the appended figures, wherein:

FIG. 1 is a schematic diagram showing an exemplary polymer cell/pouch with venting scores defined on an edge thereof;

FIG. 2 is a schematic diagram showing an alternative exemplary polymer cell/pouch with a weakened area seal defined along an edge thereof;

FIG. 3 is an exploded view of an exemplary battery system that includes a plurality of polymer cells/pouches (with tabs on opposite ends thereof) positioned within a support structure that defines a series of slots for receipt thereof;

FIG. 3A is an exploded view of the exemplary battery system of FIG. 3 with all polymer cells/pouches positioned within the slots of the support structure;

FIG. 4 is an exploded view of an alternative exemplary battery system that includes a plurality of polymer cells/pouches (with tabs in spaced orientation on the same end thereof) positioned within a support structure that defines a series of slots for receipt thereof;

FIG. 4A is an exploded view of the alternative exemplary battery system of FIG. 4 with all polymer cells/pouches positioned within the slots of the support structure;

FIG. 5 is an exploded view of a further exemplary battery system that includes a plurality of polymer cells/pouches positioned within a support structure defined by a plurality of interleaved barrier structures and top/bottom barriers/elements;

FIG. 6 is an exploded view of an exemplary casing assembly with associated safety features;

FIG. 6A is an assembled view of the exemplary casing assembly of FIG. 6;

FIG. 7 is a perspective view of an alternative exemplary casing assembly according to the present disclosure;

FIG. 8 is a perspective view of a further exemplary casing assembly according to the present disclosure;

FIGS. 9A-9C are three (3) schematic side views that show progression of a deflectable dome in response to a pressure increase within a casing according to an exemplary embodiment of the present disclosure;

FIG. 10 is a sectional side view of an exemplary deflectable dome;

FIG. 11 is a sectional depiction of the interior of a battery system that includes a venting gas pathway for controlled venting of gas generated within the battery system;

FIG. 12 is a schematic depiction of eight (8) prismatic cells in side-by-side relation with a separator positioned therebetween; and

FIGS. 13A and 13B are exploded views of alternative exemplary battery systems that include a plurality of polymer cells/pouches with tabs in spaced orientation on the same end thereof (FIG. 13B) and on opposite sides thereof (FIG. 13A), wherein the tabs are configured to provide fusing functionality according to the present disclosure.

### DETAILED DESCRIPTION

According to the present disclosure, battery systems are provided that include, inter alia, a plurality of polymer cells/pouch cell structured such that, in response to an increase in pressure within the polymer/pouch cell, e.g., a pressure increase beyond a threshold level, the polymer/pouch releases gasses in a directionally controlled manner so as to facilitate withdrawal of the gasses from the battery enclosure through a vent structure that is positioned for ease of communication with the released gasses.

Directional release of gasses from the polymer/pouch cell may be effectuated in various ways according to the present disclosure. For example, the polymer/pouch may include one or more score lines in the polymer/pouch structure that are configured and dimensioned to act as a predetermined point of failure if/when the pressure within the polymer/pouch rises, e.g., exceeds a threshold pressure level. Seam(s) associated with formation of the polymer/pouch may be weakened relative to the remainder of the polymer/pouch, e.g., through selection and/or application levels of the requisite adhesive or other modification to the sealing operation in a desired region for release of gasses upon pressure increase within the polymer/pouch, e.g., pressure increase above a threshold level.

The battery enclosure of the present disclosure is generally sealed, e.g., hermetically sealed, and the polymer cells/pouch cells are positioned within and generally spaced from each other by interleaved barrier structures, e.g., ceramic cell barriers or thermal plastics. An example of a ceramic barrier material comprises a ceramic paper, such as Kaowool made by Morgan Thermal Ceramics, or similar products made of mineral wool. An example of a thermal plastic may be be a sheet of bakelite. One or more of the interleaved barrier structures may include surface features that guide gasses that are released from a compromised polymer cell/pouch to a desired exit region. Thus, the barrier structures may define gas flow paths, e.g., based on molded features or the like.

The disclosed battery energy storage systems reduce the potential for fire/explosions by limiting the potential for thermal runaway and propagation, and by addressing risks associated with flammable/explosive gases that may lead to ignition and/or fires of an explosive nature.

The disclosed battery systems may be positioned within an open or enclosed space (e.g., a room, data center or storage system), in a vehicle and/or in a tool/appliance. The battery systems have broad applicability and utility, typically in conjunction with other conventional electronics as are known in the battery storage and energy delivery field.

The modules included in the disclosed battery systems generally include a plurality of polymer/pouch cells, e.g., lithium ion cells, that are designed to store and deliver energy. As is known in the art, the lithium ion cells include an anode, cathode, separator and electrolyte. The present disclosure is not limited by or to a particular electrolyte chemistry, and has applicability/utility across electrolyte chemistries, as are known in the art.

According to the present disclosure, module(s) associated with the disclosed battery system may include thermal insulation material(s) positioned between adjacent polymer/pouch cells, whereby the thermal insulation material(s) isolate potential temperature increases that may arise on a first side of the thermal insulation material(s) from transferring to cell(s) on a second side of the thermal insulation material(s) to the extent necessary to propagate thermal runaway and/or ignition of the cell(s) on the second side. In exemplary embodiments, the thermal insulation material(s) may be positioned so as to surround or otherwise isolate each individual cell relative to adjacent lithium ion cell(s). In other exemplary embodiments, the thermal insulation material(s) are positioned so as to surround or otherwise isolate a group or subset of the cells in the module from adjacent cell(s)/module(s). For example, groups/subsets of a plurality of polymer/pouch cells may be surrounded by or otherwise isolated from adjacent cell(s) by inter-positioning of thermal insulation material(s) (e.g., groups/subsets of two cells, of three cells, of four cells, etc.) The groups/subsets of cells may be equal in number within a given module, or may vary within a module.

The thermal isolation material(s) may take various forms and may be based on a variety of materials. For example, thermal isolation material(s) may include one or more materials that exhibit endothermic functionalities that contribute to the safety and/or stability of the batteries. In exemplary implementations of the present disclosure, the thermal isolation material(s) may include a ceramic matrix that incorporates an inorganic gas-generating endothermic material. One such inorganic gas-generating endothermic material may be ATH, Aluminum Tri Hydrate, commonly used in fire protection. In use, the thermal isolation material(s) may operate such that if the temperature rises above a predetermined level, e.g., a maximum level associated with normal operation, the thermal isolation material(s) may serve to provide one or more functions for the purposes of preventing and/or minimizing the potential for thermal runaway. For example, in addition to thermal insulation, the thermal isolation material(s) may advantageously provide one or more of the following further functionalities: (i) energy absorption; (ii) venting of gases produced, in whole or in part, from endothermic reaction(s) associated with the thermal isolation material(s), (iii) raising total pressure within the battery structure; (iv) removal of absorbed heat from the battery system via venting of gases produced during the endothermic reaction(s) associated with the thermal isolation material(s), and/or (v) dilution of toxic gases (if present) and their safe expulsion (in whole or in part) from the battery system. It is further noted that the vent gases associated with the endothermic reaction(s) dilute the electrolyte gases to provide an opportunity to postpone or eliminate the ignition point and/or flammability associated with the electrolyte gases.

The thermal insulating characteristics of the disclosed thermal isolation material(s) are advantageous in their combination of properties at different stages of their application to battery systems. In the as-made state, the thermal isolation material(s) provide thermal insulation during small temperature rises or during the initial segments of a thermal event. At these relatively low temperatures, the insulation functionality serves to contain heat generation while allowing limited conduction to slowly diffuse the thermal energy to the whole of the thermal mass. At these low temperatures, the thermal isolation material(s) are selected and/or designed not to undergo any endothermic gas-generating reactions. This provides a window to allow for temperature excursions without causing any permanent damage to the insulation and/or lithium ion battery as a whole. For lithium ion type storage devices, the general range associated as excursions or low-level rises are between 60° C. and 200° C. Through the selection of inorganic thermal isolation material(s) that resist endothermic reaction in the noted temperature range, lithium ion batteries may be provided that initiate a second endothermic function at a desired elevated temperature. Thus, according to the present disclosure, it is generally desired that endothermic reaction(s) associated with the disclosed thermal isolation material(s) are first initiated in temperature ranges of from 60° C. to significantly above 200° C. Exemplary thermal isolation material(s) for use according to the present disclosure include, but are not limited to:

TABLE 1

| | | Approximate onset of |
|---|---|---|
| Mineral | Chemical Formula | Decomposition (° C.) |
| Nesquehonite | MgCO₃•3H₂O | 70-100 |
| Gypsum | CaSO₄•2H₂O | 60-130 |
| Magnesium phosphate octahydrate | Mg₃(PO₄)₂•8H₂O | 140-150 |
| Aluminium hydroxide | Al(OH)₃ | 180-200 |
| Hydromagnesite | Mg₅(CO₃)₄(OH)₂•4H₂O | 220-240 |
| Dawsonite | NaAl(OH)₂CO₃ | 240-260 |
| Magnesium hydroxide | Mg(OH)₂ | 300-320 |
| Magnesium carbonate subhydrate | MgO•CO_{2(0.98)}H₂O_{(0.3)} | 340-350 |
| Boehmite | AlO(OH) | 340-350 |
| Calcium hydroxide | Ca(OH)₂ | 430-450 |

These thermal isolation material(s) typically contain hydroxyl or hydrous components, possibly in combination with other carbonates or sulphates. Alternative materials include non-hydrous carbonates, sulphates and phosphates. A common example would be sodium bicarbonate which decomposes above 50° C. to give sodium carbonate, carbon dioxide and water. If a thermal event associated with a lithium ion battery does result in a temperature rise above the activation temperature for endothermic reaction(s) of the selected endothermic gas-generating material, then the disclosed thermal isolation material(s) will advantageously begin absorbing thermal energy and thereby provide both cooling as well as thermal insulation to the lithium ion battery system. The amount of energy absorption possible generally depends on the amount and type of endothermic gas-generating material incorporated into the thermal isolation material(s), as well as the overall design/positioning of the endothermic materials/systems relative to the source of energy generation within the lithium ion battery. By distributing the heat to the whole thermal mass in a controlled manner, the temperature of the adjacent cells can be kept below the critical decomposition or ignition temperatures. However, if the heat flow through the thermal isolation material(s) is too large, i.e., energy conduction exceeds a threshold level, then adjacent cells will reach decomposition or ignition temperatures before the mass as a whole can dissipate the stored heat.

The thermal isolation material(s) of the present disclosure may contain a ceramic insulating matrix in combination with an inorganic endothermic material selected to produce off-gassing at temperatures above normal operating temperatures of the battery system, but lower than a predetermined temperature liable to lead to thermal runaway due to heating.

According to exemplary embodiments of the present disclosure, the amount of endothermic material is above zero and at an amount effective to provide heat-carrying and gas-diluting effects. As low as 1% by weight gas-generating endothermic material may be effective dependent upon device design, but higher quantities may be desired.

In exemplary embodiments in which the thermal isolation material(s) include a ceramic matrix and an endothermic material, the ratio of ceramic matrix to endothermic material may be in the range 1:19 to 9:1 by weight and preferably in the range 1:9 to 6:4 by weight.

Alternative relative levels may be implemented without departing from the spirit or scope of the present disclosure, provided desired functionalities are achieved within the battery system.

In exemplary embodiments in which the thermal isolation material(s) includes a ceramic matrix, the ceramic matrix typically includes inorganic fibers and binders, and may include particulate materials. The particulate materials may be microporous in nature, and may include fumed ceramics, opacifiers, and mixtures thereof. The binders may include liquid binders, dry binders or both, and may be inorganic, organic, or both. Opacifiers may be present and, dependent on product form, the thermal isolation material(s) may include water or other solvent as a constituent.

A typical but non-limiting formulation of an exemplary thermal isolation material is described in the following Table 2:

TABLE 2

| MATERIAL CATEGORY | WT. % |
|---|---|
| Ceramic Oxide Powder | 0-60 wt % |
| Opacifier | 0-30 wt % |
| Endothermic Material | 10-90 wt % |
| Dry Binder | 0-10 wt % |
| Liquid Binder | 0-60 wt % |

with the above named components amounting to greater than 60%, greater than 70%, greater than 80%, or greater than 90% of the thermal isolation material. The proportions of the components may vary according to product form. Instead of Ceramic Oxide powder also mineral fibers or powders thereof may be used as the inorganic fiber.

Inorganic fibers generally function to provide structural strength, insulating properties and to prevent shrinkage at elevated temperatures. The structural strength the fibers impart allows for the thermal isolation material(s) to resist flexural stresses that may cause excessive cracking, either during normal operation or during thermal events. Since the fibers are not organic or pure-carbon based, they will not combust and hence will not contribute to exothermic heat generation. During elevated temperature excursions, the fibers will generally serve to hold the matrix together due to their refractory nature, unlike those that combust or melt at temperatures less than the 900° C., i.e., temperatures often achieved during thermal events. Fibers that may be employed according to the present disclosure include ceramic, E-glass, S-Glass, polycrystalline, phosphoric, leached silica, quartz or zirconia fibers and spun mineral fibers from rock or clay, such as mineral fibers traded under the name rock wool and otherwise found in ceiling tiles, insulation or other fire resistant structures. Depending on design criteria, inorganic fibers may be absent, but typically may be present in amounts of 3% or more.

Microporous insulating materials typically include inorganic oxides in which the pore size is so small that the material interferes with the mean free path of gas due to convection, while also minimizing conduction through minimizing contact points between the particles. Typical materials utilized for microporous materials are ceramic oxide powders, for example, fumed silica, fumed alumina, fumed zirconia, or mixtures thereof. The amount of microporous material necessary for exemplary implementations of the present disclosure is generally a function of the nature of the battery system. According to the present disclosure, microporous material may be included in the disclosed thermal isolation material(s) at levels ranging from 0% (i.e., non-present) through to embodiments with up to 60% microporous material. The purpose of the microporous component is generally to insulate the affected cell(s) to a level that the heat flux that does flow outward is sufficiently low that it can be conveyed through the whole of the assembly by conduction without raising any point outside the affected cell(s) above the thermal ignition point. For example, if the overall design of the battery system includes relatively small cells that are sufficiently insulated and/or the battery system is characterized by relatively low energy capacity, then very little if any microporous material may be needed. For example, in such circumstance, the insulating characteristics of the ceramic fiber matrix materials may be enough. If, however, the insulated cell(s) contain(s) a high level of potential thermal energy, then a relatively high amount of microporous material may be necessary and/or desirable to prevent adjacent cells from rising above the ignition temperatures while also providing time for the endothermic materials to react and absorb energy if the temperatures become high enough.

The opacifier is a component that may augment the performance of the thermal isolation material(s) during thermal upset conditions where the temperatures rise into the levels of radiant heat. The potential need for opacifiers is generally dependent upon the heat release characteristics of the battery system analogous to the description above for the microporous component. If the temperatures during a thermal event are sufficiently high to reach radiant heat temperatures, then an opacifier will help to slow transmission of any radiant heat generated. A microporous material, fiber matrix or a combination thereof may not be effective against radiant heat transfers by themselves. Common opacifier materials include TiO₂, silicon, alumina, clay (which may function both as opacifier and binder), SiC and heavy metal oxides. These opacifiers do not provide any function at normal operating temperatures or even at lower temperatures during a thermal event. The opacifiers tend to be high in cost and very dense and, therefore, add weight to the battery system. Depending upon the design of the battery system and the nature of the heat release during a thermal event, the range for opacifier additions may range from 0 to 30 percent.

An endothermic material constituent may offer significant benefits according to exemplary embodiments of the present disclosure. It is known that most energy storage devices/lithium ion batteries function well at 60° C. or below. The disclosed endothermic materials/systems of the present disclosure are generally designed and/or selected to begin their respective endothermic reaction(s) above this temperature, but preferably low enough that the endothermic materials/systems can begin absorbing heat energy generated during a thermal event at the initial moments of such an event to minimize temperature rise in the affected cells and adjacent cells. Upon exceeding a set level above the normal operating temperature, the endothermic material absorbs heat and evolves gas. The evolving gas serves to dilute, neutralize and carry away heat. Also, the sudden generation of heat can be used to signal or cause the vents in energy storage devices to begin venting. The amount of endothermic material needed or desired generally depends upon device configuration, energy density and thermal conductivity of the remainder of the thermal isolation material(s). Endothermic materials/systems with 76% or more by weight endothermic gas-generating material are contemplated, although differing ratios and/or ranges may be employed.

The amount of endothermic gas-generating material may also be regulated to achieve a desired volume of gas generation and the selection of type can be used to set the temperature at which the endothermic gas generation should occur. In highly insulating systems, a higher temperature may be desired whereas, in less insulating systems, a lower temperature may be needed to prevent temperatures in neighboring cells reaching critical ignition temperature. Typical inorganic endothermic materials that meet these requirements include, but are not limited to, the following endothermic materials:

TABLE 3

| | | Approximate onset of |
|---|---|---|
| Mineral | Chemical Formula | Decomposition (° C.) |
| Nesquehonite | MgCO₃•3H₂O | 70-100 |
| Gypsum | CaSO₄•2H₂O | 60-130 |
| Magnesium phosphate octahydrate | Mg₃(PO₄)₂•8H₂O | 140-150 |
| Aluminium hydroxide | Al(OH)₃ | 180-200 |
| Hydromagnesite | Mg₅(CO₃)₄(OH)₂•4H₂O | 220-240 |
| Dawsonite | NaAl(OH)₂CO₃ | 240-260 |
| Magnesium hydroxide | Mg(OH)₂ | 300-320 |
| Magnesium carbonate subhydrate | MgO•CO_{2(0.98)}H₂O_{(0.3)} | 340-350 |
| Boehmite | AlO(OH) | 340-350 |
| Calcium hydroxide | Ca(OH)₂ | 430-450 |

As noted above, these endothermic materials typically contain hydroxyl or hydrous components, possibly in combination with other carbonates or sulphates. Alternative materials include non-hydrous carbonates, sulphates and phosphates. A common example would be sodium bicarbonate which decomposes above 50° C. to give sodium carbonate, carbon dioxide and water.

In exemplary embodiments of the present disclosure, polymer/pouch cells associated with a multi-core electrochemical assembly are located in a housing, where individual polymer/pouch cells are separated by an interleaved barrier structure. Each of the polymer/pouch cells may be surrounded in part or in full by the barrier materials. One of the purposes of using a housing is to increase safety through delaying heat propagation between polymer/pouch cells upon thermal abuse. Another purpose of the housing is to mechanically protect the polymer/pouch cells by absorbing damage otherwise made by impact energy, external penetration, prevention of vibration damages to the structure, to mention a few mechanical failures.

In further exemplary embodiments of the present disclosure, a plurality of endothermic materials are incorporated into the same energy storage device/battery, wherein the constituent endothermic materials initiate their respective endothermic reactions at different temperatures. For example, sodium bicarbonate may be combined with ATH, (Al(OH)₃, aluminum trihydrate) to provide a dual response endothermic material/system according to the present disclosure. In such exemplary implementation, the sodium bicarbonate can be expected to begin absorbing energy and evolving gas slightly above 50° C., whereas ATH would not begin absorbing energy and evolving gas until the system temperature reached approximately 180-200° C. Thus, it is specifically contemplated according to the present disclosure that the endothermic material may be a single material or mixture of endothermic materials.

It should be noted that some materials have more than one decomposition temperature. For example, hydromagnesite referred to above as having a decomposition temperature starting in the range 220-240° C. decomposes in steps: first by release of water of crystallization at about 220° C.; then at about 330° C. by breakdown of hydroxide ions to release more water; then at about 350° C. to release carbon dioxide. However, these steps in decomposition are fixed and do not permit control of at what temperatures heat is absorbed and at what temperatures gas is generated.

By use of a mixture of two or more endothermic materials having different decomposition temperatures, the cooling effect can be controlled over a wider temperature range than with one material alone. The two or more endothermic materials may comprise one or more non-gas generating endothermic materials in combination with one or more gas-generating materials.

By use of a mixture of two or more endothermic materials evolving gas at different decomposition temperatures, the production of gas can be controlled over a wider temperature range than with one material alone. The number and nature of endothermic materials used can hence be tailored to give tailored heat absorption and gas evolution profiles. Such tailoring of heat absorption and gas evolution profiles by mixing different endothermic materials allows the control of the evolution of temperature and pressure to meet design requirements of the apparatus in which the material is used.

The binder phase of the insulation can be inorganic or organic in nature, but is preferably inorganic. The intent of the binder phase is to provide adequate structural integrity to assemble the device, hold the cells in place during normal operation and, optionally, to provide mechanical stability during a thermal event. The type and amount of binder can be varied to allow for the desired rigidity necessary for assembly and in-service mechanical performance. An example of a binder that would allow a highly flexible insulation material is a natural and/or synthetic latex material. One or more starches could be used to produce more rigid formations. Thermosetting binders may also be utilized, especially when high levels of microporosity are utilized. For those applications where organic binders are not desirable, then inorganic binders are advantageously employed, such as, but not limited to sodium silicate, potassium silicate, colloidal silica and colloidal alumina. Refractory clay(s), such as kaolin, may also be used as binder(s). These clays also contain water, which at highly elevated temperatures volatizes off in an endothermic manner, providing further benefit in the disclosed systems. All of the inorganic binders can be added to the insulating material either in solution/suspension or in a dry form depending upon the forming process employed.

It is noted that not all constituent materials disclosed with respect to the endothermic materials/systems of the present disclosure are compatible with the commonly applied manufacturing routes. For this reason, the design requirements of a particular energy storage device/battery may dictate the necessary and/or desired manufacturing route. In selecting manufacturing method(s) for a particular application, it is noted that:
a. A brittle material is not as good as a material that can be deformed without cracks during mechanical abuse. Accordingly, manufacturing methods and formulations that minimize the brittleness, and increase the deformability, of the disclosed endothermic materials/systems are generally preferable.
b. A material that is soft is generally preferable as compared to a hard material from a point of not being able to penetrate the polymer/pouch cells and cause internal shorts. On the other hand, a hard material can increase the strength so that crash can be mitigated and protect the polymer/pouch cells. Accordingly, manufacturing methods and formulations that optimize the noted balance of soft/hard attributes in fabricating the disclosed endothermic materials/systems are generally preferable.
c. Once the cell or module is deformed, it is desirable that the endothermal protection is as homogenous as possible even after the crash, so that thermal protection is intact. Accordingly, manufacturing methods and formulations that deliver homogeneity are generally preferable.
d. If the endothermic material/system contains water and is to be used with an energy storage device sensitive to water, the vapor pressure of water associated with the endothermic material/system in normal operating temperatures of the associated electrical storage device is desirably low.
e. Differing regions of a device that includes a plurality of electrical storage devices may require different levels of endothermic materials and so a material having different concentrations of endothermic material through its extent may be applied. For example the material may include:
   a surface region having a higher concentration of endothermic material than a region within the body of the material; and/or
   a surface region having a higher concentration of endothermic material than a different surface region of the material

By way of example, four exemplary manufacturing methodologies/formulation combinations are described below. However, the present disclosure is not limited by or to these exemplary modalities.

### Dry Pressing

One exemplary method of manufacture of the disclosed endothermic materials/systems according to the present disclosure is to first dry blend the constituents together and then press them into a desired initial shape under high pressures until a microporous structure is formed. If high green strengths are desired, then a dry thermosetting binder can be added in the blending step, in which case the shape is held at temperatures below that at which gas would evolve from the endothermic material, but high enough to set the thermosetting binder. This can be done either during the pressing step or afterward. Once completed, the resulting shape can be machined to the specified design. A typical formulation for this manufacturing route is given below.

TABLE 4
Typical dry pressed shape formulation

| MATERIAL CATEGORY | WT. % |
|---|---|
| Ceramic Powder | 0-60 wt % |
| Opacifier | 0-30 wt % |
| Endothermic Material | 10-60 wt % |
| Dry Binder | 0-10 wt % |
| Fiber | 3-15 wt % |

### Infiltration of a Preform

In an alternative exemplary method of manufacture of the disclosed endothermic materials/systems according to the present disclosure, the product is formed in a process in which a fiber component is first preformed into a shape (preform), and then subsequently infiltrated with a suspension containing the remaining constituents.

The preform may be created using commonly applied vacuum forming techniques employed by other industries, such as pulp molding, paper and ceramic fiber shapes. In these processes, a dilute suspension of the fiber component in a liquid (a slurry) is exposed to a mesh screen upon which the slurry constituents build up as the liquid (typically water) is drawn through. The concentration of the slurry varies to match the process being used and fiber properties. An organic or inorganic binder may also be incorporated into this step. Once the shape (or flat material) builds to a desired thickness, it is removed from the suspension and dried until sufficient handling strength and open porosity is achieved to allow for infiltration.

Infiltration may be accomplished by submerging the preform (or flat material) into a suspension of the remaining non-fiber constituents of the present disclosure. Capillary action draws the suspension into the porosity, displacing air in the process. Infiltration can be assisted through the application of either vacuum or pressure, if needed. The infiltrated part is then dried to remove water. Once water is removed, the binder (if present) will harden. The resultant material can then be further machined and/or processed, if required, or used as is, if appropriate.

This manufacturing route lends itself to producing formulations with high endothermic material loading, readily achieving an 80% loading and extendable to higher loadings still. Table 5 shows the dry ingredients of a typical fiber preform (where there is reference to liquid binder, this means the set residue of a liquid binder).

TABLE 5
Typical fiber preform formulation (dry)

| MATERIAL CATEGORY | WT. % |
|---|---|
| Ceramic Oxide Powder | — |
| Opacifier | — |
| Endothermic Material | — |
| Dry Binder | 0-10 wt % |
| Liquid Binder | 10-40 wt % |
| Fiber | 50-90% |

The following Table 6 shows a typical infiltration suspension (where there is reference to liquid binder, this means the liquid binder before setting).

TABLE 6
Typical infiltration suspension

| MATERIAL CATEGORY | WT. % |
|---|---|
| Ceramic Oxide Powder | — |
| Opacifier | 0-20 wt % |
| Endothermic Material | 4-85 wt % |
| Dry Binder | 0-5 wt % |
| Liquid Binder | 0-40 wt % |
| Fiber | — |
| Water | 15-45 wt % |

A typical composition for the resulting final shape of the present disclosure produced by this manufacturing route is given below (where there is reference to liquid binder, this means the set residue of a liquid binder).

TABLE 7
Typical final formulations for infiltrated part

| MATERIAL CATEGORY | WT. % |
|---|---|
| Ceramic Oxide Powder | — |
| Opacifier | 0-16 wt % |
| Endothermic Material | 32-80 wt % |
| Dry Binder | 0-5 wt % |
| Liquid Binder | 2-40 wt % |
| Fiber | 10-18 wt % |

### Vacuum Forming

One characteristic of the infiltration technique is the presence of a concentration gradient of the non-fiber constituents. The concentration is greatest on the outer surfaces and decreases towards the center. This is caused by the insulating matrix acting as a filter and restricting infiltrate as it travels further the surface. One-method for reducing non-uniform distribution is to form the disclosed endothermic material/system with all the constituents in one step. In this exemplary vacuum forming manufacturing method, all of the constituent materials are introduced into the initial dilute slurry suspension. The suspension is then formed into the desired shape (or flat material) via standard vacuum forming techniques commonly applied in pulp molding, paper and ceramic fiber industries. The resulting part or paper is then dried and can be used as made, or further machined.

This technique has the advantage of producing a more homogenous shape, but is not well suited for producing formulations with very high loadings of non-fiber constituents. This is due to blinding of the forming screens that interferes with the ability of the suspension to be pulled through. This technique is, therefore, more applicable to thin products, such as papers, or near net shapes where the cross sections are less than 10 mm in thickness. The use of a water suspension generally precludes the use of fumed oxides because these materials cannot create microporous structures once exposed to water.

The following Table 8 shows typical vacuum formed shape chemistry excluding process water and in which, where there is reference to liquid binder, this means the unset liquid binder.

TABLE 8
Typical vacuum formed shape chemistry

| MATERIAL CATEGORY | WT. % |
|---|---|
| Ceramic Oxide Powder | — |
| Opacifier | 0-30 wt % |
| Endothermic Material | 10-85 wt % |
| Dry Binder | 0-10 wt % |
| Liquid Binder | 3-15 wt % |
| Fiber | 3-60 wt % |

### Moldable Products

The endothermic materials/systems according to the present disclosure can also be made as a moldable material for use in forming the assembly of the energy storage device/battery instead of in the form of an article. The manufacturing of the moldable version typically starts with wet mixing constituents in a mixer until well mixed (e.g., for approximately 10 minutes). A biocide may be added at this point to prevent mold growth during storage. pH modifiers may be included, if required. Once mixing is complete, the moldable products can then be packaged into caulking tubes or drums for storage and distribution prior to assembly. During assembly, the moldable material may be injected, pressed, or otherwise placed into the areas to be insulated and the resultant assembly dried to remove water. Typically, if an inorganic binder is used, then the dried part will adhere very tightly to the non-insulation components, adding to the structural integrity of the device. Such a moldable material requires little or no additional machining after drying.

A typical formulation for the moldable production method in given below in Table 9. Due to the nature of fumed ceramic oxides, they generally cannot be wet processed with water, so this manufacturing method normally precludes their incorporation into implementations of the present disclosure.

TABLE 9
Typical mouldable formulation

| INGREDIENTS | WT. % |
|---|---|
| Ceramic Oxide Powder | — |
| Opacifier | 0-15 wt % |
| Endothermic Material | 10-60 wt % |
| Clay Binder | 0-10 wt % |
| Liquid Binder | 5-60 wt % |
| Fiber | 0-10 wt % |
| Added Liquid (e.g., Water) | 0-70 wt % |

It should be noted that the liquid present may include the liquid binder and/or also include added liquid. Setting agents for the liquid binder may be included in the added liquid.

### Other Forms

The materials may be in the form of a foam that is chemically and/or mechanically foamed. Foamed ceramics are known for insulation purposes [e.g. U.S. Pat. No. 4,596,834] and the endothermic material may include part of the constituents of the foam and/or be subsequently impregnated into the foam. Compositions similar to the moldable composition may be foamed.

### Typical Compositions

Below are given exemplary compositions that have been demonstrated to provide effective endothermic properties/functionalities according to the present disclosure.

TABLE 10

| | | Pressed | Injectable | Infiltrated | Vacuum Shape |
|---|---|---|---|---|---|
| Material Category | Description | Shape | Paste | Board | or Paper |
| Ceramic Oxide | Fumed silica type P | 36.50 | 0.00 | 0.00 | 0.00 |
| Powder | | | | | |
| Ceramic Oxide | Micronized silica | 7.50 | 0.00 | 0.00 | 0.00 |
| Powder | | | | | |
| Endothermic | Alumina Trihydrate | 49.00 | 47.00 | 80.00 | 72.40 |
| Material | | | | | |
| Binder | Heat Set Resin binder | 2.00 | 0.00 | 0.00 | 0.00 |
| Binder | Latex Binder | 0.00 | 0.00 | 0.00 | 6.11 |
| Binder | Potassium Silicate | 0.00 | 10.00 | 0.00 | 0.00 |
| | (48% solids content) | | | | |
| Binder | Colloidal Silica | 0.00 | 0.00 | 4.72 | 1.36 |
| (Stabilizer for | HCl (20% Solution) | 0.00 | 40.00 | 0.00 | 0.00 |
| Binder) | | | | | |
| Binder | Starch | 0.00 | 0.00 | 1.57 | 0.00 |
| Fiber | SUPERWOOL ® plus | 0.00 | 3.00 | 10.24 | 20.14 |
| | bulk fiber (alkaline | | | | |
| | earth silicate fiber) | | | | |
| Fiber | ½″ E-glass | 1.00 | 0.00 | 0.00 | 0.00 |
| Fiber | Denka B97T4 Alumina | 4.00 | 0.00 | 3.46 | 0.00 |
| | Fiber | | | | |
| | | 100.00 | 100.00 | 100.00 | 100.00 |

### Nature of Shaped Material

The above description refers to forming shapes, including flat shapes such as boards and papers. These shapes for the present application may have particular forms. For example, the shapes may include:
a body of material having a recess shaped to receive an energy storage device/battery or cell thereof;
a body of material having a plurality of recesses, each shaped to receive an energy storage device/battery or cell thereof;
a material having two or more regions having different concentrations of endothermic material;
a material having a gradient of endothermic gas-generating material;
a material that includes a surface region of the material having a higher concentration of endothermic material than a region within the body of the material;
a material that includes a surface region of the material having a higher concentration of endothermic material than a different surface region of the material.

With reference to the exemplary implementations of the disclosed endothermic materials/systems, it is noted that the positioning/location of thereof within an energy storage device/lithium ion battery is generally selected so as to facilitate the desired energy absorption/transfer functionalities described herein without interfering with the underlying energy generation and storage associated with such energy storage device/lithium ion battery. Moreover, it is generally desirable that the disclosed endothermic materials/systems be positioned/located so as to permit effective gas communication with associated venting functionality, thereby permitting prompt and effective degassing of gaseous by-products generated by the endothermic reaction(s) of the present disclosure.

In exemplary embodiments of the present disclosure, the thermal isolation material(s) may take the form of blanket or mat positioned in contact with (or in close proximity to) jelly roll assemblies or polymer pouch cells housed within a support member. The disclosed blanket may substantially limit the quantity of hot particulate residue, e.g., liquid electrolyte and electrolyte gas, from interacting with adjacent polymer/pouch cells if/when released from one or more polymer/pouch cell(s).

The disclosed blanket may feature flow characteristics that promote axial gas and fluid flow through the blanket, but substantially reduce lateral (e.g., side-to-side) flow within the blanket. Therefore, particulates associated with such gas/fluid flow are forced through the body of the blanket and into the shared atmosphere of the battery system enclosure (or an individual compartmentalized region of the battery system). To the extent an applicable threshold pressure is reached within the shared atmosphere, the particulate-containing gas/fluid is vented from the enclosure, as described herein.

In an illustrious embodiment, the blanket may be fabricated from a ceramic material (or similar material) with a pore size/structure that promotes axial flow therethrough. The ceramic material is typically stable at relatively high temperatures, e.g., greater than 200° C. In exemplary embodiments of the present disclosure, the pore size of the disclosed blanket is sized so as to (i) capture larger hot particulates/debris, e.g., larger sized carbonized debris, metal debris, metal oxide particulates and melted metal particulates, so as to ensure those larger particulates/debris do not contact adjacent jelly rolls, and (ii) facilitate smaller particulates and gas in passing through the blanket and out the vent (if the vent is activated). Smaller particulates for purposes of the present disclosure are those particulates that will pass freely through the vent so as to not become trapped/clogged within the vent outlet. In an illustrious embodiment, the blanket may be installed beneath a vent or under a holding structure such as a bus bar; however, the blanket may also be installed above the bus bar.

Although the foregoing structure for controlling gas/fluid flow from electrochemical unit(s) is described as a blanket, it is noted that the desirable functionality of controlling gas/fluid flow may be achieved by a plurality of discrete elements that are positioned in proximity to the electrochemical units, e.g., in a one-on-one manner. Thus, individual gas/fluid flow elements may be positioned in proximity to the weakened features of the polymer/pouch cells to facilitate axial/non-lateral flow of gas/fluid that is expelled therefrom—while capturing larger particulates-as described above with reference to the noted blanket. In like manner, the disclosed structure for controlling gas/fluid flow may be configured/dimensioned as a structure that provides flow control functionality with respect to a sub-set of electrochemical units positioned within the enclosure.

In an exemplary embodiment, the thermal isolation material(s) (including the disclosed blanket) may be fabricated, in whole or in part, from a thermally insulating mineral material (e.g., AFB® material, Cavityrock® material, ComfortBatt® material, and Fabrock™ material (Rockwool Group, Hedehusene, Denmark); Promafour® material, Microtherm® material (Promat Inc., Tisselt, Belgium); and/or calcium-magnesium-silicate wool products from Morgan Thermal Ceramics (Birkenhead, United Kingdom). The thermally insulating mineral material may be used as a composite and include fiber and/or powder matrices. The mineral matrix material may be selected from a group including alkaline earth silicate wool, basalt fiber, asbestos, volcanic glass fiber, fiberglass, cellular glass, and any combination thereof. The mineral material may include binding materials, although it is not required. The disclosed building material may be a polymeric material and may be selected from a group including nylon, polyvinyl chloride (“PVC”), polyvinyl alcohol (“PVA”), acrylic polymers, and any combination thereof. The mineral material may further include flame retardant additives, although it is not required, an example of such includes alumina trihydrate (“ATH”). The mineral material may be produced in a variety of mediums, such as rolls, sheets, and boards and may be rigid or flexible. For example, the material may be a pressed and compact block/board or may be a plurality of interwoven fibers that are spongey and compressible. Mineral material may also be at least partially associated with the inner wall of a battery system enclosure, so as to provide an insulator internal thereto.

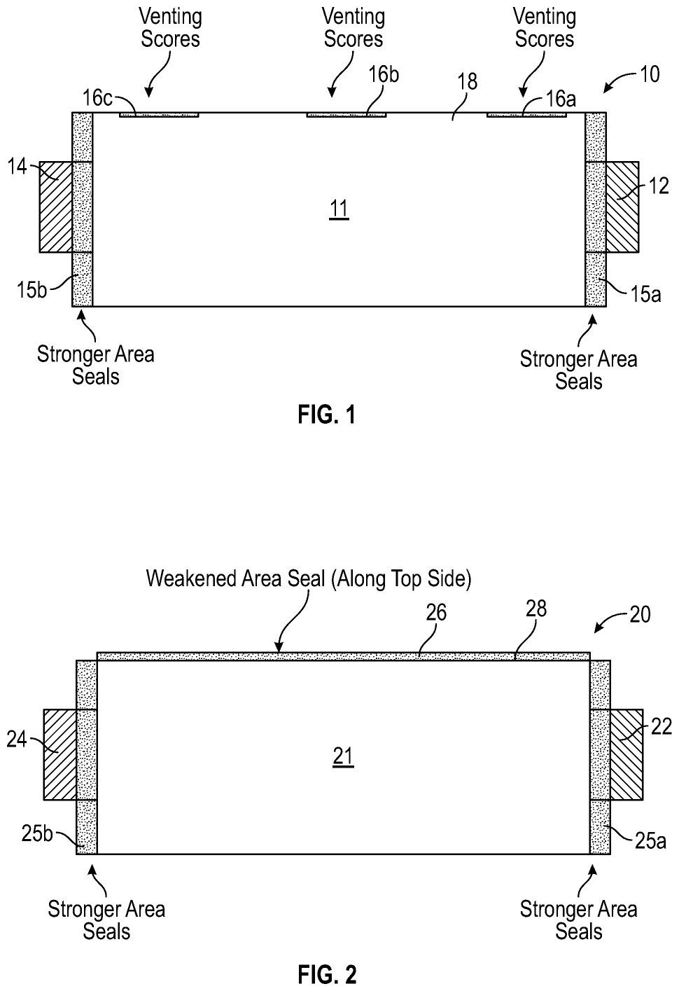

Turning to exemplary embodiments depicted in the accompanying figures, FIG. 1 schematically depicts a polymer/pouch cell 10 that includes a pouch 11 with first/second tabs 12, 14 extending from opposite ends thereof for electrical communication with the overall circuitry of the battery system in which the polymer/pouch cell 10 will be deployed. The pouch 11 is sealed around its periphery (see, e.g., seals 15a, 15b), thereby isolating the electrochemical assembly positioned therewithin from the external environment. However, pouch 11 includes venting scores 16a, 16b, 16c along an elongated edge 18 thereof. The venting scores 16a, 16b, 16c define preferential regions of failure in the event pressure within pouch 11 increases. Based on the location of the preferential regions of failure (i.e., venting scores 16a, 16b, 16c), gas flow from the pouch 11 will preferentially exit in the direction and, at least initially through, the pouch region(s) weakened by the venting scores 16a, 16b, 16c. By controlling the direction and/or location of vented gas, the overall battery system can control the gas flow path so as to minimize the potential for gas interaction with adjacent pouches/modules, and to direct the gas to a region in proximity to a vent from the battery system. Moreover, in exemplary embodiments of the present disclosure, the gas flow path may be directed into a shared atmosphere region within the sealed battery enclosure, thereby reducing the overall pressure build-up associated with the gas release from pouch 11 and allowing the vent from the battery system to operate at lower pressures. The combination of benefits associated with the venting scores 16a, 16b, 16c serve to reduce the likelihood of a cascading failure within the battery system associated with a release of gases from pouch 11. The external vent furthers serves the purpose of directing the flammable gases away from the cell assembly.

Of note, although FIG. 1 schematically depicts three venting scores along edge 18, the disclosed embodiment is not limited by or to the number and relative positioning of venting scores 16a, 16b, 16c. Rather, more or fewer venting scores may be provided along edge 18 and the relative positioning of such venting scores may be equidistant or variable in spacing (e.g., grouped toward tab 12 or tab 14, based on the desired gas flow path). Additionally, the individual venting scores may be equivalent in length/depth, or may vary in length, depth or both, to further define preferential failure regions associated with the present disclosure. Of further note, the tabs 12, 14 are deployed on opposite ends of pouch 11. However, the tabs 12, 14 could be deployed in spaced relation to each other on the same end of pouch 11.

Turning to FIG. 2, an alternative embodiment technique for establishing a preferential zone of failure associated with a polymer/pouch cell 20 is schematically depicted. Polymer/pouch cell 20 includes a pouch 21 with first/second tabs 22, 24 extending from opposite ends thereof for electrical communication with the overall circuitry of the battery system in which the polymer/pouch cell 20 will be deployed. The pouch 21 is sealed around its periphery (see, e.g., seals 25a, 25b), thereby isolating the electrochemical positioned therewithin from the external environment. However, pouch 21 includes a weakened area seal 26 along an elongated edge 28 thereof. The weakened area seal defines a preferential region of failure in the event pressure within pouch 21 increases. Based on the location of the preferential region of failure (i.e., weakened area seal 26), gas flow from the pouch 21 will preferentially exit in the direction and, at least initially through, the weakened area seal 26. By controlling the direction and/or location of vented gas, the overall battery system can control the gas flow path so as to minimize the potential for gas interaction with adjacent pouches/modules, and to direct the gas to a region in proximity to a vent from the battery system. Moreover, in exemplary embodiments of the present disclosure, the gas flow path may be directed into a shared atmosphere region within the sealed battery enclosure, thereby reducing the overall pressure build-up associated with the gas release from pouch 21 and allowing the vent from the battery system to operate at lower pressures. The combination of benefits associated with the weakened area seal 26 serves to reduce the likelihood of a cascading failure within the battery system associated with a release of gases from pouch 21. For cells that are compressed by external mechanical structure, the weakening structure can be at the tab.

In some cases, it may be beneficial to leave the structure open to allow for gas to escape during the formation process and then seal an external structure around the multiple cells in an assembly. For aluminum prismatic cell structures sealing with laser welding is a preferred and commercially available common manufacturing process.

Of note, although FIG. 2 schematically depicts a continuous weakened area seal 26 along edge 28, the disclosed embodiment is not limited by or to implementations that include a continuous weakened edge. Rather, the weakened area seal 26 may be variable in weakness along edge 28 such that there are regions of greater weakness as compared to other areas along edge 28 to further define preferential failure regions associated with the present disclosure. Of further note, the tabs 22, 24 are deployed on opposite ends of pouch 21. However, the tabs 22, 24 could be deployed in spaced relation to each other on the same end of pouch 21.

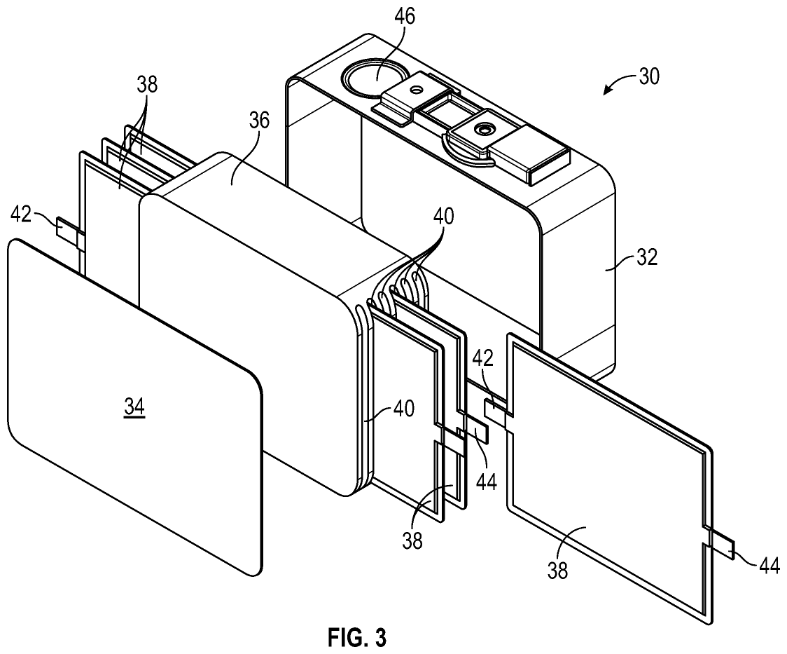

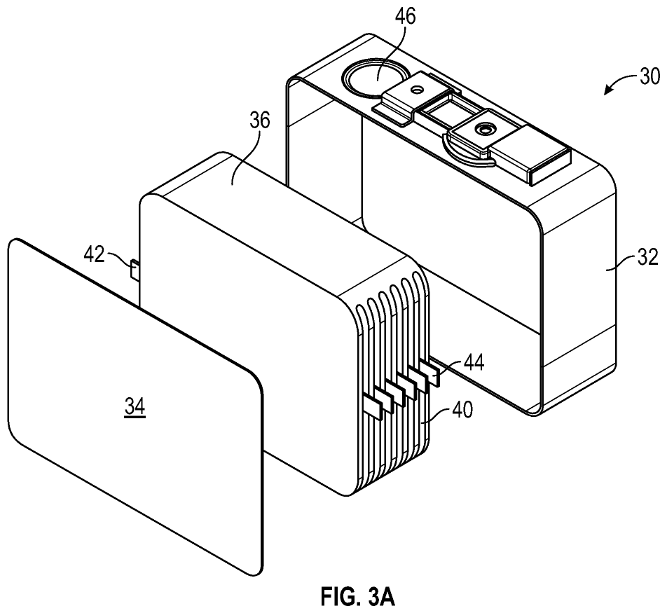

With reference to FIGS. 3 and 3A, exploded views of an exemplary battery system 30 are provided. Battery system 30 includes a case 32, a cover 34, a support structure 36 and a plurality of polymer/pouch cells 38. When fully assembled, case 32 and cover 34 define a sealed enclosure, e.g., a hermetically sealed enclosure. The support structure 36 defines a plurality of spaced slots 40 that extend through the support structure 36 and are configured and dimensioned for receipt of individual polymer/pouch cells 38. For illustration purposes in FIG. 3, three of the polymer/pouch cells 38 are depicted in an extended manner on a first side of support structure 36, two of the polymer/pouch cells 38 are depicted in an extended manner on a second side of support structure 36, and the sixth polymer/pouch cell 38 is fully removed from support structure 36. However, as shown in FIG. 3A, when fully assembled, each of the polymer/pouch cells 38 is positioned within a slot 40 defined by support structure 36.

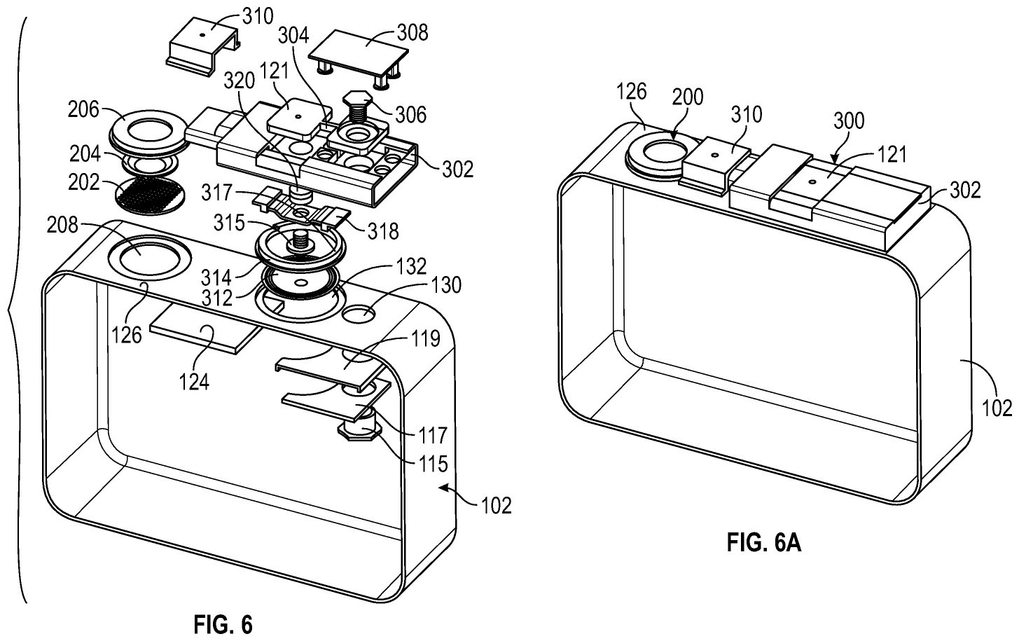

Each of the polymer/pouch cells 38 includes first and second tabs 42, 44 extending from opposite ends of the polymer/pouch cell 38. Each of the polymer/pouch cells 38 includes structure(s)/feature(s) that define preferential region(s) of failure, e.g., as described hereinabove with reference to FIGS. 1 and 2. Thus, the polymer/pouch cells 38 may include venting scores along an edge, a weakened area seal or a combination thereof. In this way, if pressure increases within a polymer/pouch cell 38, the flow of vented gasses will be controlled so as to be directed by a desired path and to a desired region within case 32. In the exemplary embodiment of FIGS. 3 and 3A, the desired region for receipt of the vented gases is in proximity to vent 46 that extends through a face of case 32. The features and functions of vent 46 and the other elements mounted with respect to the face of case 32 are described hereinbelow, e.g., with reference to FIGS. 6, 9A-9C and 10.

The individual polymer/pouch cells should preferably be assembled using a fuse that upon an internal short in one of the cell is designed to disconnect the incident cell. This will disallow current to flow into the failing cell that may further worsen the cell failure and cause additional heat with possibility of propagation. Such a fuse can be manufactured by removing metal from parts of the positive and negative tabs of the polymer/pouch cells or by using fusing structures implemented as part of the bus bar structure that connects to one or both of the tabs of the polymer/pouch cells.

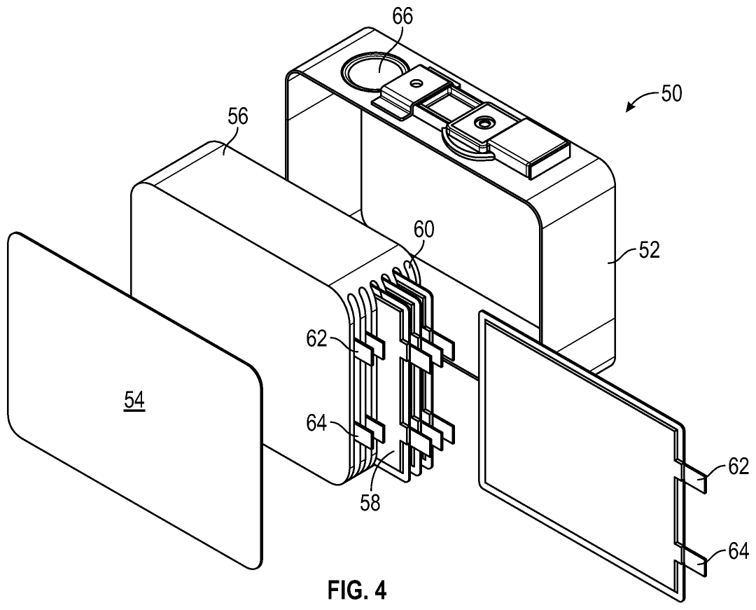

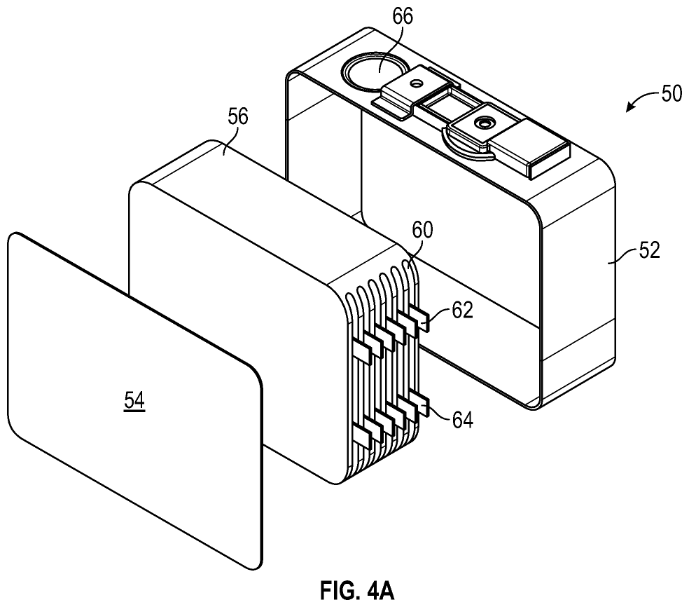

Turning to FIGS. 4 and 4A, exploded views of an alternative exemplary battery system 50 are provided. Battery system 50 includes a case 52, a cover 54, a support structure 56 and a plurality of polymer/pouch cells 58. When fully assembled, case 52 and cover 54 define a sealed enclosure, e.g., a hermetically sealed enclosure. The support structure 56 defines a plurality of spaced slots 60 that extend through the support structure 56 and are configured and dimensioned for receipt of individual polymer/pouch cells 58. As shown in FIG. 4A, when fully assembled, each of the polymer/pouch cells 58 is positioned within a slot 60 defined by support structure 56.

Each of the polymer/pouch cells 58 includes first and second tabs 62, 64 in spaced relation and extending from the same end of the polymer/pouch cell 58. Each of the polymer/pouch cells 58 includes structure(s)/feature(s) that define preferential region(s) of failure, e.g., as described hereinabove with reference to FIGS. 1 and 2. Thus, the polymer/pouch cells 58 may include venting scores along an edge, a weakened area seal or a combination thereof. In this way, if pressure increases within a polymer/pouch cell 58, the flow of vented gasses will be controlled so as to be directed by a desired path and to a desired region within case 52. In the exemplary embodiment of FIGS. 4 and 4A, the desired region for receipt of the vented gases is in proximity to vent 66 that extends through a face of case 52. The features and functions of vent 66 and the other elements mounted with respect to the face of case 52 are described hereinbelow, e.g., with reference to FIGS. 6, 9A-9C and 10.

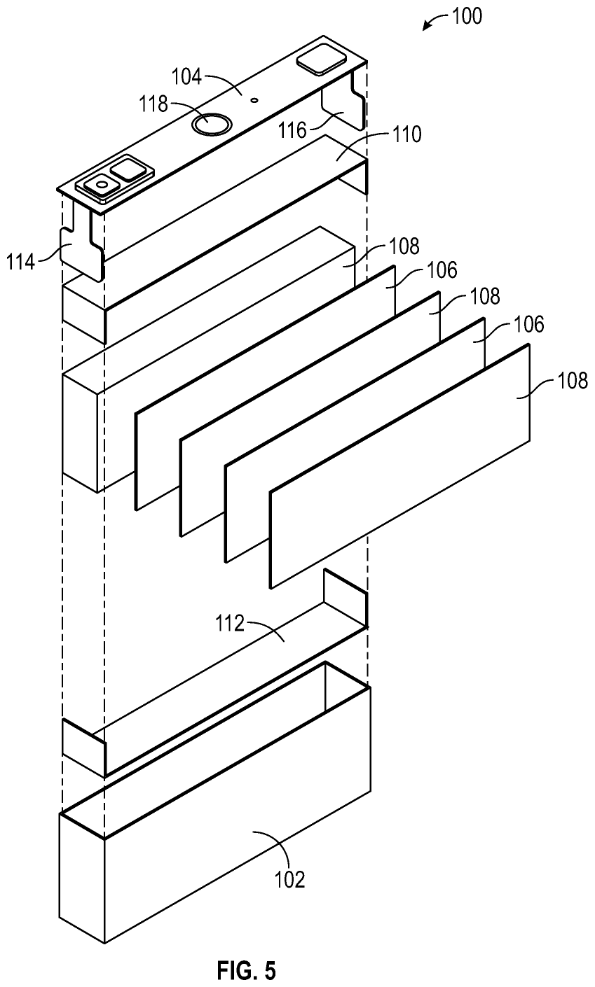

Turning to FIG. 5, a further exemplary embodiment of a battery system according to the present disclosure is schematically depicted. Battery system 100 includes a case 102 and a cover 104 that, when assembled, define a sealed enclosure, e.g., a hermetically sealed enclosure. Battery system 100 further includes a plurality of polymer/pouch cells 106 that are spaced from each other by interleaved barrier structures 108. Of note, in FIG. 5, only two of the polymer/pouch cells 106 and two of the interleaved barrier structures 108 are exploded relative to the remainder of the cells/barrier structures (which are shown in close proximity to each other). A top barrier 110, e.g., a ceramic top barrier or Bakelite barrier (alone or in combination with a mineral material or felt-like material), and a bottom barrier 112, e.g., a ceramic bottom barrier, cooperate to capture the polymer/pouch cells 106. In combination, the top barrier 110, the bottom barrier 112 and the interleaved barrier structures 108 define a support member that supports the plurality of polymer/pouch cells 106 for introduction to the enclosure defined by case 102 and cover 104. Of note, the interleaved barrier structures provide multiple functional benefits, including (i) blocking electrical connection between adjacent cells, (ii) providing a heat barrier between adjacent cells, and (iii) providing a material barrier between adjacent cells. Downwardly extending tabs 114 and 116 are associated with terminals positioned on cover 104 and electrically communicate with tabs (not pictured) that extend from the polymer/pouch cells 106.

Each of the polymer/pouch cells 106 includes structure(s)/feature(s) that define preferential region(s) of failure, e.g., as described hereinabove with reference to FIGS. 1 and 2. Thus, the polymer/pouch cells 106 may include venting scores along an edge, a weakened area seal or a combination thereof. In this way, if pressure increases within a polymer/pouch cell 106, the flow of vented gasses will be controlled so as to be directed by a desired path and to a desired region within the enclosure defined by case 102 and cover 104. In the exemplary embodiment of FIG. 5, the desired region for receipt of the vented gases is in proximity to vent 118 that extends through a face of cover 104. The features and functions of vent 118 and the other elements mounted with respect to the face of cover 104 are described hereinbelow, e.g., with reference to FIGS. 6, 9A-9C and 10.

It should be noted that for some assemblies an external structure that is not hermetically sealed may be used, as long as the structure allows the fusing mechanism and direction of the flammable gases away from the hot areas of the cell assembly. Such assemblies would preferentially have a venting area nearby the cell assembly, so that the flammable gas can quickly lower its concentration below its flammability levels. Such dispersion is important to avoid potential explosions upon failures of one polymer/pouch cell.

Of note with reference to the exemplary embodiment described with reference to FIG. 5 (and with applicability to the other embodiments described with reference to FIGS. 1-4):
The lithium ion core members can be wound jelly roll or stacked unit
The electrolyte can be liquid, gel or solid electrolyte
The housing with cavities can be a continuous integrated block
The housing/support structure with cavities can be formed by plates or sheets, e.g., interleaved barriers.
The liner for lithium ion core members may be polymer materials, e.g., polymer laminated metal foils.
The liner may have at least one opening to allow the atmosphere of or in the lithium ion core member to communicate with other core members.
The lithium ion core members in the cell before sealing the cell case can be at the state of just post-electrolyte application without any electrochemical process or after electrochemical formation
The interleaved barrier structures may include protruding features/structures that further guide the gas flow in a desired direction or along a desired path in the event of gas is released from a polymer/pouch cell
In exemplary embodiments, released gases are directed to a shared atmosphere region, i.e., an open region to which vented gas from each of the plurality of polymer/pouch cells will be directed, and the shared atmosphere region is in communication with (and preferably in close physical proximity to) a vent that is configured to discharge gases to the atmosphere when a threshold pressure is exceeded within the battery system.

In establishing a vent structure in battery systems of the type disclosed herein, it is desirable to provide a vent mechanism that operates at very low pressures (P3 in FIG. 1) without risking nuisance failures in regular use due to that relatively high metal residuals can be maintained at the score site. This low pressure for P3 in turn allows use of mechanically sealed cans/containers, or alternatively laser welding can be used to seal the can, because the P4pressure may also be reduced without risking an overlap with P3. Thus, the ability to reliably reduce P3 may translate to an overall improvement in battery system design and operation.

Moreover, the area of the vent should be relatively large to allow a reliable opening pressure with a controllable flow area, allowing for quicker pressure release and eliminating atomization of the electrolyte. A larger vent area should generally produce a design with increased safety.

In exemplary embodiments of the present disclosure that include a venting mechanism alone (i.e., without a pressure disconnect device), the vent pressure (P3) is on the order of about 10 psig to about 140 psig, and the structural limit pressure of the container (P4) is at least about 10% higher than the vent pressure.

In exemplary embodiments that include both a pressure disconnect device and a venting mechanism, the pressure at which the pressure disconnect device is activated is generally dependent on the overall design of the lithium ion battery. However, the threshold pressure within the casing which activates the disclosed pressure disconnect device is generally 10psig or greater, and is generally in the range of 10-40 psig. In embodiments that also include a venting mechanism, the pressure at which the vent mechanism is activated to vent, i.e., release pressurized gas from the casing, is generally at least 5 psig greater than the pressure at which the pressure disconnect device is activated. Thus, for example, if the pressure disconnect device is set to activate at 15 psig, then in exemplary embodiments of the present disclosure, the independent vent structure may be selected so as to vent at 20 psig. Of note, the overall pressure rating of the casing itself, i.e., the pressure at which the casing may fail, is generally set at a pressure of at least 5 psig greater than the pressure at which the vent structure is activated. Thus, in the example described above (activation of pressure disconnect device at 15 psig; activation of vent structure at 20 psig), the casing is generally designed to withstand an internal pressure of at least 25 psig. The pressure rating of the casing has particular importance with respect to interface welds and other joints/openings that include sealing mechanisms where failures are more likely to occur. An exemplary pressure disconnect would operate at 20 psig to 50 psig, and vent at 60 psig to 300 psig, where the structure holds >310 psig, leaving a manufacturing window relative to the design pressure.

Several vent type geometric shapes exist today and are generally designed to fail at score line(s) defining the vent at specified pressures. The main concern with straight line vents, “Y” vents, and radial vents is that they generally do not open completely since the crack propagation may not always choose the same path. A round vent is generally preferred because it can quickly open a large area and the residual metal flap can quickly bend out of the way so that gas can be released without significant pressure increase of the container. Optimal vent designs are effective in that, upon a venting event, all gas can quickly be released without build-up of increased pressure inside the can/container due to further gas generation.

For example, for circular or substantially circular vent openings, an opening diameter of about 1½ inches may provide suitable vent functionality for batteries of the present disclosure, although alternative diameter openings may be employed based on features/functions of a specific battery implementation. For non-circular vent openings, an overall vent area of between about 0.4 cm² to about 12 cm² may be effectively employed, although again alternative vent areas may be provided based on the features/functions of specific battery implementations.

Although an increased vent area limits atomization of the electrolyte in connection with a venting event, there is a risk for flashback. Such flashback can ignite the electrolyte of isolated electrode structures inside the cell that have not failed during the abuse conditions, such as an internal short. In order to limit this risk, a flame arrestor may be advantageously positioned in proximity to the vent in order to prevent a flame front from reentering the enclosure containing the multi-roll structure. In exemplary embodiments of the present disclosure, a flame arrestor is positioned internal to the vent structure, i.e., across the area defined by and/or in the vicinity of the score line that forms/defines the vent structure and/or initiates the vent functionality.

In the event of a failure of an individual jellyroll or pouch/polymer cell structure, a large amount of gas is generated (˜10 liters), and this gas is both hot (˜250-300° C.) and flammable. It is likely that this gas will ignite outside of the multi-jellyroll enclosure after a vent occurs. To prevent and/or reduce the likelihood that the flame will enter the cell, a mesh may be advantageously placed/positioned over the vent area to function as a flame arrestor. This mesh functions to reduce the temperature of the exiting gas stream below its auto-ignition temperature.

Since the mesh is serving as a heat exchanger, greater surface area and smaller openings reject more heat, but decreasing the open area of the mesh increases the forces on the mesh during a vent. A 30 US standard mesh, 0.012″ wire diameter, has been found to be effective in preventing flashback for the large Li-ion batteries tested. Other mesh sizes are expected to function effectively, but the 30 mesh is preferred due to its general supply availability and effective arrestor function for Li-ion batteries. A 30 mesh has an open area of 40%, which means that in a vent at 70 psi, the mesh must withstand instantaneous forces of 70 psi*0.6 =42 lbf/in² of vent area. For reasonable vent areas, such as those used for the Li-ion application, calculated stresses in the mesh from this loading are modest. For instance, for a 2 inch diameter vent, (larger than can be fit on the sidewall of a conventional battery container), the instantaneous stress in the mesh at vent is roughly:

$$( ( pi * 1 {in}^{2} ) * 42 lb f / {in}^{2} ) / ( pi * 2 in * 0.012 * 0.6 * 0.7854 ) \text{=\textasciitilde} 3714 psi$$

The yield strength of copper is ˜20,000 psi.

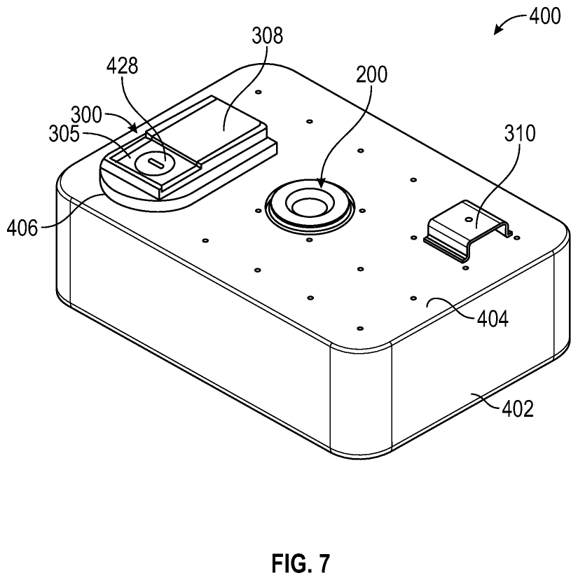

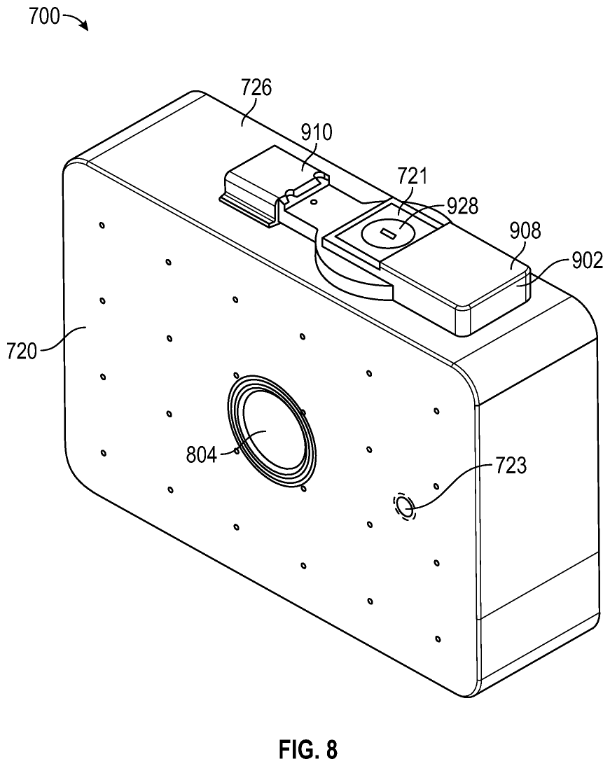

With further reference to FIGS. 6, 6A, 7 and 8 (collectively, FIGS. 6-8), exemplary safety features associated with the disclosed battery systems are provided, and include a vent assembly 200 and a pressure disconnect device (PDD) assembly 300. According to the exemplary battery of FIGS. 6-8, operative components of vent assembly 200 and PDD assembly 300 are mounted/positioned along a top wall 126 of outer can 102. However, alternative positioning (in whole or in part) of one or both of vent assembly 200 and/or PDD assembly 300 may be effectuated without departing from the spirit/scope of the present disclosure, as will be apparent to persons skilled in the art based on the present disclosure.

With initial reference to vent assembly 200, it is noted that the top wall 126 of outer can or casing 102 defines an opening 128. A flame arrestor 202 and a vent disc 204 are mounted across the opening 128. A seal is maintained in the region of flame arrestor 202 and vent disc 204 by vent adapter ring 206. Various mounting mechanisms may be employed to fix vent adapter ring 206 to top wall 126, e.g., welding, adhesive, mechanical mounting structures, and the like (including combinations thereof). Of note, vent disc 204 is necessarily sealingly engaged relative to top wall 126 and may be formed in situ, e.g., by score line(s) and/or reduced thickness relative to top wall 126, as is known in the art.

As noted above, in the event of a failure of an individual jelly roll (or multiple jelly rolls) or a polymer/pouch cell, a large amount of gas may be generated (˜10 liters), and this gas is both hot (˜250-300° C.) and flammable. It is likely that this gas will ignite outside of the multi-jelly roll enclosure after a vent occurs. To prevent the flame front from entering the casing, a mesh may be provided to function as flame arrestor 202 and may be advantageously placed or positioned over the vent area, i.e., opening 128. This mesh functions to reduce the temperature of the exiting gas stream below its auto-ignition temperature. Since the mesh is serving as a heat exchanger, greater surface area and smaller openings reject more heat, but decreasing the open area of the mesh increases the forces on the mesh during a vent.

Turning to the electrical aspects of the disclosed battery, the exploded view of Fig, 6 shows upstanding copper terminal 115 which functions as the anode for the disclosed lithium ion battery and is configured and dimensioned to extend upward thru a further opening 130 formed in the top wall 126 of outer can or casing 102. The upstanding terminal 115 is in electric communication with the copper bus bar 114 and bus bar connector 117 internal to casing 102, and extends thru bus bar connector insulator 119 so as to be exposed upward and outward of outer can/casing 102. The upper end of upstanding copper terminal 115 is positioned within fuse holder 302, which may define a substantially rectangular, non-conductive (e.g., polymeric) structure that is mounted along the top wall 126 of outer can/casing 102. Upstanding terminal 115 is in electrical communication with terminal contact face 121 by way of fuse 304.

Fuse 304 is positioned within fuse holder 302 and external to outer can/casing 102 in electric communication with upstanding copper terminal 115 and terminal contact face 121. A terminal screw 306 may be provided to secure fuse 304 relative to fuse holder 302 and upstanding terminal 115, and the fuse components may be electrically isolated within the fuse holder 302 by fuse cover 308.

A substantially U-shaped terminal 310 defines spaced flange surfaces 311 that are in electrical and mounting contact with the top wall 126 of outer can/casing 102. Aluminum bus bar 104 which is internal to casing 102 is in electrical communication with the outer can/casing 102, thereby establishing electrical communication with terminal 310. Terminal 310 may take various geometric forms, as will be readily apparent to persons skilled in the art. Terminal 310 is typically fabricated from aluminum and functions as the cathode for the disclosed lithium ion battery.

Thus, the anode terminal contact face 121 and cathode terminal 310 are positioned in a side-by-side relationship on the top wall 126 of casing 102 and are available for electrical connection, thereby allowing energy supply from battery 100 to desired application(s).

With reference to exemplary PDD assembly 300, a conductive dome 312 is positioned with respect to a further opening 132 defined in the top wall 126 of outer can/casing 102. Dome 312 is initially flexed inward relative to the outer can/casing 102, and is thereby positioned to respond to an increase in pressure within the outer can by outward/upward deflection thereof. Dome 312 may be mounted with respect to top wall 126 by a dome adapter ring 314 which is typically welded with respect to top wall 126. In exemplary implementations and for ease of manufacture, dome adapter ring 314 may be pre-welded to the periphery of dome 312, thereby facilitating the welding operation associated with mounting dome 312 relative to top wall 126 due to the increased surface area provided by dome adapter ring 314.

In the exemplary embodiment depicted in FIGS. 6-8, a non-conductive (i.e., insulative) hammer holder 315 is positioned in engagement with a top face of the dome 312, thereby electrically isolating dome 312 from the underside of terminal contact face 121, as described below.

However, it is contemplated that the non-conductive hammer holder 315 and braid assembly may be eliminated in alternative implementations of the present disclosure, as described herein. In an exemplary non-braid implementation, upward/outward deflection of dome 312 (based on an increased pressure within outer can/casing 102) may bring dome 312 into direct contact with the underside of terminal contact face 121. In selecting this approach, care should be taken that the current running thru the dome 312 does not negatively impact the structural integrity of the dome 312. In this respect, the hammer holder/braid assembly implementation described with reference to the embodiment of FIGS. 6-8 offers an exemplary approach to avoiding and/or minimizing potential structural damage and/or failure of the dome by electrically isolating the dome from direct contact with the terminal contact face 121.

With further reference to FIG. 6, hammer holder 315 includes an upward extension that is configured and dimensioned to pass through an opening defined in conductive braid 317 and snap connect to disconnect hammer 320 positioned on the other side of braid 317. In this way, hammer holder 315 and disconnect hammer 320 are secured with respect to braid 317 and move in concert therewith. The braid 317 is mounted with respect to a braid base 316 by braid clamps 318 and the subassembly is fixed relative to the top wall 126 of outer can/casing 102, e.g., by welding. Of note, conductive braid 317 is extensible so as to accommodate upward movement of dome 312, hammer holder 315 and disconnect hammer 320 relative to outer can/casing 102.

In use and in response to a build-up in pressure within the assembly defined by outer can/casing 102 and top cover 120, dome 312 will deflect upward relative to top wall 126 of outer can/casing 102. Upon sufficient upward deflection, i.e., based on the internal pressure associated with battery 100 reaching a threshold level, disconnect hammer 320 is brought into contact with the underside of terminal contact face 121 which is in electrical communication with fuse 304 within fuse holder 302. Upward movement of disconnect hammer 320 is permitted due to a “stretching” of braid 317. Contact between disconnect hammer 320 (which is conductive) completes a circuit that runs from cover 126 thru braid 317, hammer head 320, terminal contact face 121, fuse 302, and upstanding terminal 115. The completion of this circuit will cause fuse 302 to “blow”, thereby breaking the circuit from the multi-core components positioned within the assembly defined by outer can 102 and top cover 120. Current is bypassed through the outer can 102. Of note, all operative components of PDD assembly 300—with the exception of the deflectable dome 312—are advantageously positioned external to the outer can 102 and top cover 120.

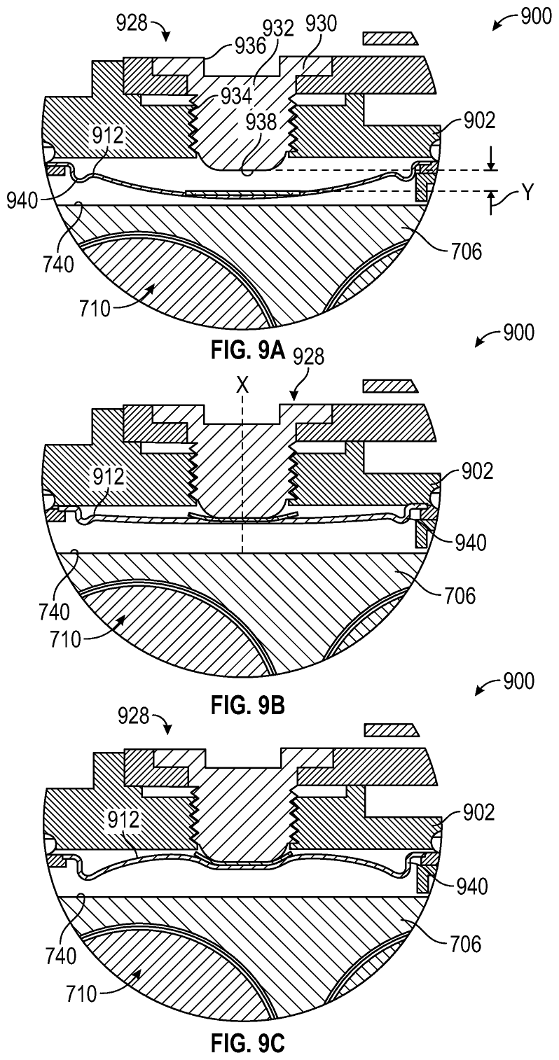

Turning to FIG. 9, an exploded view of an alternative exemplary multi-core lithium ion battery 400 is provided. An assembled view of the exemplary lithium ion battery is provided in FIG. 9A. FIG. 9 provides an alternate position for vent assembly 200 and PDD assembly 300 as was initially described with reference to the embodiment of FIGS. 5-8.

With reference to FIGS. 9A-9C, additional features and functions of PDD 900, including exemplary specifically dome 912 and hammer head 928, are described according to the present disclosure. Hammer head 928 defines a circumferential flange or head region 930 and a threaded shank 932 extending therefrom. The threaded shank 932 is adapted to engage corresponding threads formed in an aperture 934 defined in fuse holder 902. Head region 930 cooperates with terminal contact face 721 to define a substantially flush upper face thereof. A drive feature 936 is defined on the head region 930 to facilitate interaction with a tool, e.g., a screw driver or the like, to threadingly engage hammer head 928 relative to aperture 932. Once threaded into place, hammer head 928 is securely held in the desired position relative to dome 912, thereby ensuring reliable and exacting electrical contact between dome 912 and hammer head 928 when pressure conditions within the battery casing activate the dome 912.

In the assembled condition shown in FIGS. 9A-9C, the distal face 938 of hammer head 928 advantageously extends beyond the underside of fuse holder 902. The central axis of hammer head 928 (shown as dashed line “X” in FIG. 9B) is substantially aligned with the center of circular dome 912. In the initial position of FIG. 9A, dome 912 is bowed away from the distal face 938 of hammer head 928. This relative orientation reflects a condition wherein the pressure within the volume bounded by can 702 and top cover 720 is within normal operating ranges, i.e., not at an elevated level such that a deflection response of dome 912 has been initiated. The pressure associated with normal operating condition of a lithium ion battery according to the present disclosure will vary depending on many factors, including the power/energy capacity of the battery, the number of jelly rolls/electrochemical units positioned within the casing, the volume of the shared atmosphere region, the composition of the electrolyte (including specifically the type and level of degassing agent).

In typical lithium ion battery implementations of the present disclosure wherein the battery capacity is 30 Amp-hours or greater, operating pressures under normal conditions are between 0 and 5 psig. Accordingly, operating pressures of between 10 psig and 70 psig may be deemed acceptable for PDD activation, although lower pressure ranges, e.g., pressures in the range of 10 psig to 30 psig, may be deemed acceptable pressure operating ranges in exemplary implementations of the present disclosure. The PDD of the present disclosure is designed so as to be responsive at a selected pressure (or limited pressure range) within the casing of the battery, e.g., 20 psig±0.1 psig or the like. Of note, the PDD activation pressure may be selected at least in part to ensure that the temperature within the battery casing does not exceed acceptable levels, e.g., an internal temperature that does not exceed 110° C. to 120° C. If the internal temperature is permitted to exceed about 110° C. to 120° C., significant issues may arise that could lead to internal short(s) of the jelly roll(s)/electrochemical unit(s) (e.g., based on separator shrinkage or rupturing) and/or thermal runaway. According to the present disclosure, activation of the disclosed PDD at the predetermined pressure threshold is generally effective to prevent against thermal runaway and other potentially catastrophic failure conditions.

In particular and in exemplary embodiments of the present disclosure, when the internal pressure reaches the PDD threshold value, the dome disc pops up to contact the hammer head causing a short circuit between positive and negative terminals, which results in fuse failure. After the fuse has failed (i.e., “blown”), the negative terminal connecting to the external circuit is isolated from jelly rolls in the container, and the negative terminal is kept connecting to the positive terminal via the case and hammer head, resulting in current directly flowing from the negative terminal to the case, i.e., by-passing jelly rolls.

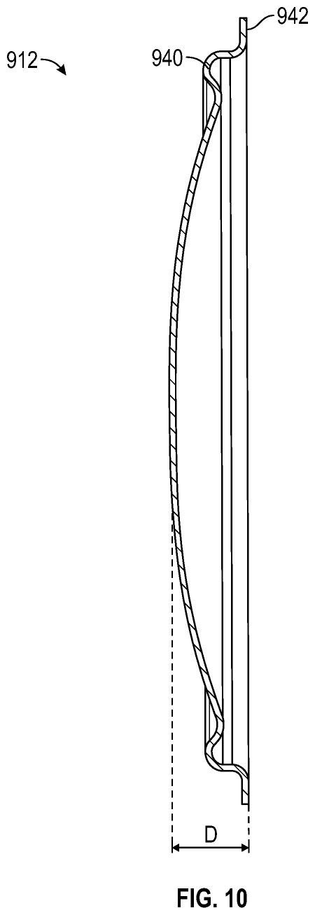

In an exemplary embodiment of the present disclosure, and as shown in the cross-section of FIG. 10, dome 912 (prior to addition of conductive film disc 913) may include or define a circumferential groove 940 at an outer periphery thereof (but internal of circumferential mounting flange 942). The groove 940 facilitates response of dome 912 to internal pressures developed within the battery casing.

In an exemplary embodiment of the present disclosure where dome 912 is fabricated from aluminum such that the central region thickness is about 0.015 to 0.022 inches (with or without film disc 913), the diameter of dome 912 (exclusive of mounting flange region 942) is about 1.18 inches, and the diameter of dome 912 internal of groove 940 is about 1.03 inches, the radius of the distal face 938 of hammer head 928 is about 0.06 to 0.08 inches, and the activation pressure is about 20 to 25 psig, the distance “D” from the top face of mounting flange 942 to the surface of dome 912 at a center point thereof once the film disc 913 (diameter of about 0.404 inches) is applied to the central region of dome 912 (not shown in FIG. 10) is about 0.115 inches to about 0.123 inches.

The PDD of the present disclosure may be designed for activation at a first pressure, e.g., 10 to 40 psig (or higher, depending on battery design), the vent assembly may be designed for activation (i.e., pressure release/venting) at a second pressure that is at least 5 to 10 psig higher than the activation pressure of the PDD, and the overall design of the battery casing (i.e., welds, seals, joints and the like) may be designed with a failure pressure rating that is at least 5 to 10 psig higher than the activation pressure of the vent assembly. In this way, the sequence for safety response of the battery design may be established so as to minimize risks associated with battery design and operation.

As is apparent from each of the disclosed battery systems, the PDD components and the vent structure of the present disclosure advantageously interact with and respond to conditions within the battery casing based on components that are mounted with respect to apertures/openings formed directly in the can or lid of the casing. For example, the disclosed dome is mounted with respect to an opening formed in the can itself in FIG. 6, while the disclosed dome may be mounted with respect to an opening formed in the lid. Equally beneficially, the vent is mounted with respect to an opening formed directly in the can in FIG. 6, while the disclosed vent may be mounted with respect to an opening formed in the lid as well.

No intermediate or accessory structure is required to support the PPD and/or vent structures of the present disclosure. Indeed, only one additional opening relative to the interior of the battery is required according to the embodiments of the present disclosure, i.e., an opening to accommodate passage of the Cu terminal. The simplicity and manufacturing/assembly ease of the disclosed battery systems improves the manufacturability and cost parameters of the disclosed battery systems. Still further, the direct mounting of the PDD and vent assemblies relative to the can and/or lid of the disclosed batteries further enhances the low profile of the disclosed batteries. By low profile is meant the reduced volume or space required to accommodate the disclosed PDD and vent safety structures/systems, while delivering high capacity battery systems, e.g., 30 Ah and higher.

### Mitigation of arc Generation Relative to Dome in Exemplary Pressure Disconnect Devices

To avoid a potential for dome disc burn-through that might create hole(s) due to arc generation when the dome is activated, two advantageous design options have been developed according to the present disclosure: (i) a thicker dome disc, and (ii) welding additional foil on the disc. The two options may be independently implemented, or they may be implemented in combination.

Both thickening of the dome disc and welding additional foil on the dome disc (thereby increasing mass in the region of the dome disc) have been shown to eliminate burn-through hole in the dome disc when applying 800 A DC current. The results of these tests are shown in the tables set forth below.

TABLE 11
Dome disc in PDD subassembly after applying high DC current

| Dome | Weld | | Activation | Applied | | |
|---|---|---|---|---|---|---|
| material & | metal & | Hammer | pressure | current | | Dome |
| thickness | thickness | radius | (psig) | (A) | Fuse | damage |
| Al / 0.012″ | N/A | 0.025″ | 20-25 | 800 | Littelfuse | Big burn- |
| | | | | | MIDI | through hole |
| Al / 0.012″ | N/A | 0.060″ | 20-25 | 800 | 200A | Small burn- |
| | | | | | | through hole |
| Al / 0.015″ | N/A | 0.060″ | 35 | 800 | | No burn- |
| | | | | | | through |
| Al / 0.012″ | 0.004″ Al | 0.060″ | 20-25 | 800 | | No burn- |
| | | | | | | through |
| Al / 0.012″ | 0.004″ Al | 0.080″ | 20-25 | 800 | | No burn- |
| | | | | | | through |
| Al/0.012″ | N/A | 0.025″ | 20-25 | 800 | Cadenza | Big burn- |
| | | | | | | through |
| Al/0.012″ | 0.010″ Al | 0.060″ | 20-25 | 900 | | No burn- |
| | | | | | | through |
| Al / 0.012″ | Cu tape | 0.060″ | 20-25 | 800 | Littelfuse | No burn- |
| | (3M 1187) | | | | MIDI | through |
| | | | | | 200A | |

The effect of thickness and type of additional welding metal foil on dome disc popping pressure with different thickness Al foils and Cu foil welded on the Al dome disc has been investigated. Based on these studies and as shown in Table 12, the Al foil thickness or Cu foil thickness has no significant effect on dome popping pressure.

TABLE 12
Dome popping pressure with welded additional foil

| Additional foil | Foil thickness | Dome popping pressure (psi) | | |
|---|---|---|---|---|
| material | (inch) | Max | Min | Average |
| Al | 0.004 | 22 | 20 | 22 |
| Al | 0.010 | 22 | 20 | 21 |
| Al | 0.012 | 25 | 19 | 21 |
| Cu | 0.010 | 23 | 20 | 21 |
| Specification | N/A | 15 | 25 | 20 |

The additional metal foil can advantageously act as a sacrificial layer when an arc is generated, thereby protecting the dome disc from burning through. In addition, the larger thermal mass and lower resistance associated with the options disclosed herein beneficially reduces the local heat at the contact area between the hammer and dome disc. It is expected that the thicker and more conductive the foil is, the more effective the disclosed designs will be in preventing the arc from burning through.

In implementing designs to mitigate the risk of burn through when the dome is activated, i.e., when the disclosed pressure disconnect device is triggered, it is noted that the selection and use of different materials may be beneficially employed. For example, materials that exhibit a higher melting point may be advantageous because they will less readily burn through. Also, the electrical conductivity of the selected material may benefit the design and operation of the dome trigger, e.g., materials that exhibit greater electrical conductivity will more effectively/rapidly dissipate current from the dome region, thereby reducing the risk of burn through.

Indeed, the speed with which the dome (or other PDD trigger mechanism) responds to a pressure disconnect condition impacts on the degree to which the design must mitigate against potential burn through, i.e., the more quickly the dome/trigger responds, the less likely a burn through condition may occur (and vice versa). Thus, for a given PDD release pressure (e.g., 40 psi), a dome/trigger mechanism that is designed to respond at that pressure can be expected to respond at a certain speed based on its material(s) of construction, geometry, thickness/mass, etc. For a second PDD release pressure (e.g., 90 psi), a particular dome/trigger mechanism that is designed to respond at that pressure can be expected to respond at a potentially different speed based on its material(s) of construction, geometry, thickness/mass, etc. According to the present disclosure, the design of the dome/trigger mechanism may be selected (e.g., based on material(s) of construction, geometry, thickness/mass, etc.) so as to prevent burn through in view of the expected speed of PDD response.

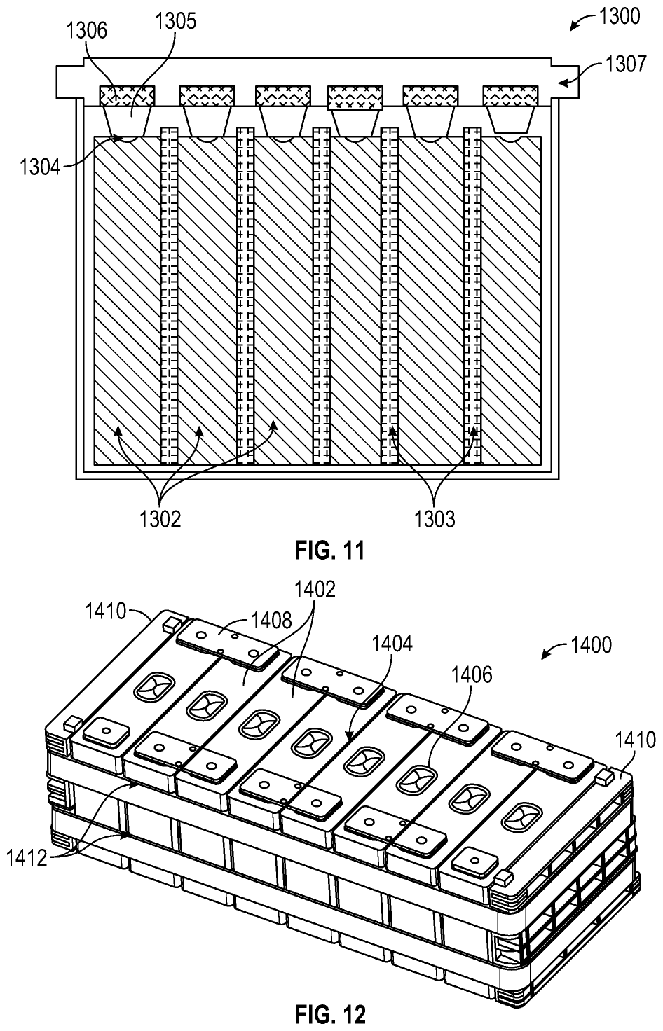

With reference to FIG. 11, a sectional side view of a battery module 1300 is provided that includes a plurality of cells 1302 in side-by-side relation. A thermal insulating mat 1303 is positioned between adjacent cells 1302, thereby minimizing heat transfer therebetween. When a cell 1302 undergoes thermal runaway, its vent 1304 opens. A ceramic cup 1305 is located above the vent 1304, so that the venting gas flows through the ceramic cup 1306. A thermal insulating cover layer 1306 is placed between each individual ceramic cup 1305 and a venting gas passing channel 1307 that extends transversely thereabove. The venting gas passing channel 1307 is in communication with each of the ceramic cups 1305 associated with respective cells 1302. When a cell 1302 undergoes venting and thermal runaway, the thermal insulating cover layer 1306 will be blown off by the venting gas, and the venting gas is guided into the gas passing channel 1307. The thermal insulating cover layers 1307 covering other ceramic cups 1305 prevent the venting gas in the venting gas passing channel 1307 from flowing back to other cells 1302 in the module 1300. Thus, the venting gas is prevented from reaching neighboring cells.

It is generally preferred that the venting gas passing channel 1307 is pre-filled with inert gas, such as nitrogen, carbon dioxide, etc. When the venting gas flows into the gas passing channel 1307, it will not be ignited due to the absence of air. To enable pre-filling inert gas, the venting gas passing channel 1307 needs to be sealed. The seals between the venting gas passing channel 1307 and individual ceramic cup(s) 1305 can be placed under each thermal insulating cover layer 1306. These seals need to be sufficiently weak to allow the venting gas to break through such seal. In addition, at least one of the ends of the venting gas passing channel 1307 is also weakly sealed to allow the venting gas to flow therethrough in instances where venting of gas from a cell 1302 has occurred. Both ends of the venting gas passing channel 1307 may be weakly sealed to allow potential release of vent gas at both ends thereof.

According to exemplary embodiments, the venting gas passing channel 1307 can be used for individual modules, but also shared by multiple modules in a battery pack/unit.

Turning to FIG. 12, a perspective view of an exemplary battery module 1400 is provided. Module 1400 includes eight (8) cells 1402 in side-by-side relation. A mat 1404, e.g., a ceramic mat, is positioned between adjacent cells 1402 to minimize heat transfer therebetween. A vent 1406 is provided for each of the cells 1402 to allow venting of gases that are generated by the cell, e.g., in the case of thermal runaway. Adjacent cells 1402 are in electrical communication with each other based on busbars 1408 that communicate between the terminals of adjacent cells 1402. A pair of module end plates 1410 are provided, one at each end of module 1400, and module straps 1412 extend around the overall module assembly to secure the cells relative to each other. Thus, each of module straps 1412 extends around the two module end plates 1410 and the side-by-side cells 1402 (with ceramic mats 1404 positioned therebetween) to define an assembled battery module 1400.

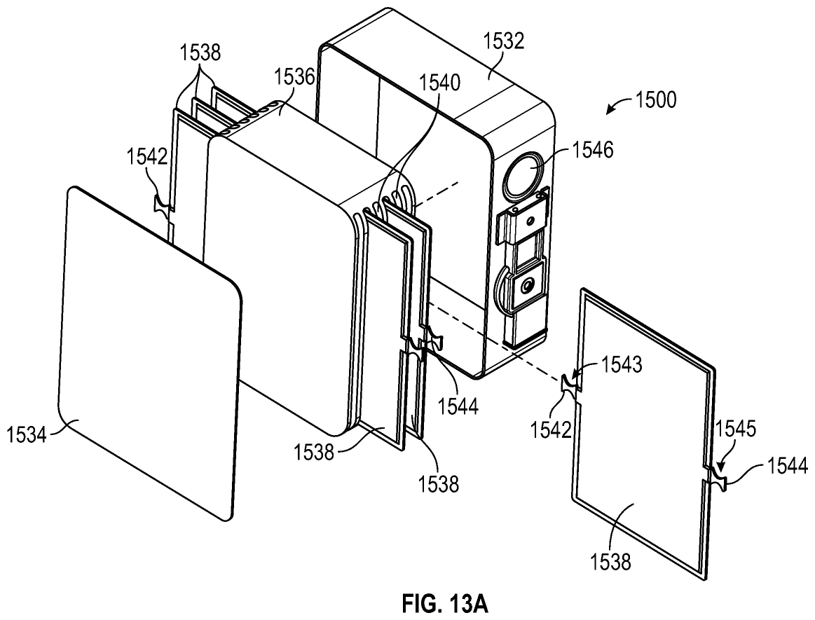

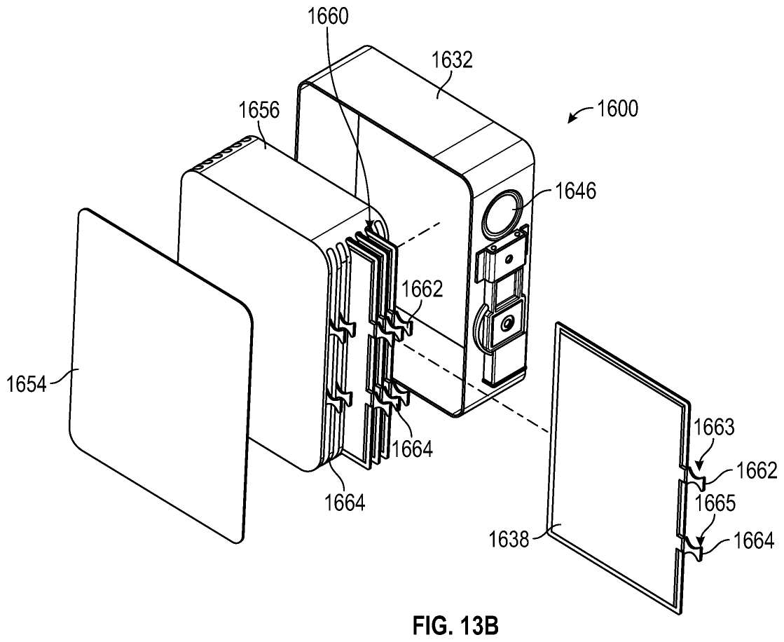

Turning to FIGS. 13A and 13B, exploded views of alternative exemplary battery systems 1500 and 1600 are provided. Battery systems 1500/1600 correspond to battery systems 30/50 as schematically depicted in FIGS. 3 and 4, except that battery systems 1500/1600 include tabs that provide fusing functionality, as described herein.

Thus, battery system 1500 in FIG. 13A includes a case 1532, a cover 1534, a support structure 1536 and a plurality of polymer/pouch cells 1538. When fully assembled, case 1532 and cover 1534 define a sealed enclosure, e.g., a hermetically sealed enclosure. The support structure 1536 defines a plurality of spaced slots 1540 that extend through the support structure 1536 and are configured and dimensioned for receipt of individual polymer/pouch cells 1538. When fully assembled, each of the polymer/pouch cells 1538 is positioned within a slot 1540 defined by support structure 1536.

Each of the polymer/pouch cells 1538 includes first and second tabs 1542, 1544 extending from opposite ends of the polymer/pouch cell 1538. The first/second tabs 1542/1544 are substantially T-shaped and define first/second neck regions 1543/1545 that are of reduced width/mass as compared to the tab regions on either side of first/second neck regions 1543/1545. The reduced width/mass of first/second neck regions 1543/1545 provide fuse functionality to the individual polymer/pouch cells 1538, such that an increase in current flow across tab 1542 or 1544 (relative to an associated busbar) beyond a threshold level will cause the applicable neck region 1543/1545 to fail, thereby creating an internal short and breaking electrical communication between the relevant polymer/pouch cell 1538 and the associated busbar (not shown). In this way, a polymer/pouch cell 1538 that reaches an unstable condition will be electrically isolated from the battery system through fuse-like failure of the neck region associated with the affected tab. Thus, each individual polymer/pouch cell includes a fuse that upon an internal short disconnects the incident cell. This will disallow current to flow into the failing cell that may further worsen the cell failure and cause additional heat with possibility of propagation.

Each of the polymer/pouch cells 1538 includes structure(s)/feature(s) that define preferential region(s) of failure, e.g., as described hereinabove. Thus, the polymer/pouch cells 1538 may include venting scores along an edge, a weakened area seal or a combination thereof. In this way, if pressure increases within a polymer/pouch cell 1538, the flow of vented gasses will be controlled so as to be directed by a desired path and to a desired region within case 1532. In the exemplary embodiment of FIG. 13A, the desired region for receipt of the vented gases is in proximity to vent 1546 that extends through a face of case 1532. The features and functions of vent 1546 and the other elements mounted with respect to the face of case 1532 are described hereinabove, e.g., with reference to FIGS. 6, 9A-9C and 10.

Turning to FIG. 13B, an exploded view of an alternative exemplary battery system 1650 is provided. Battery system 1650 includes a case 1652, a cover 1654, a support structure 1656 and a plurality of polymer/pouch cells 1658. When fully assembled, case 1652 and cover 1654 define a sealed enclosure, e.g., a hermetically sealed enclosure. The support structure 1656 defines a plurality of spaced slots 1660 that extend through the support structure 1656 and are configured and dimensioned for receipt of individual polymer/pouch cells 1658. When fully assembled, each of the polymer/pouch cells 1658 is positioned within a slot 1660 defined by support structure 1656.

Each of the polymer/pouch cells 1658 includes first and second tabs 1662, 1664 in spaced relation and extending from the same end of the polymer/pouch cell 1658. The first/second tabs 1642/1644 are substantially T-shaped and define first/second neck regions 1643/1645 that are of reduced width/mass as compared to the tab regions on either side of first/second neck regions 1643/1645. The reduced width/mass of first/second neck regions 1643/1645 provide fuse functionality to the individual polymer/pouch cells 1638, such that an increase in current flow across tab 1642 or 1644 (relative to an associated busbar) beyond a threshold level will cause the applicable neck region 1643/1645 to fail, thereby creating an internal short and breaking electrical communication between the relevant polymer/pouch cell 1638 and the associated busbar (not shown). In this way, a polymer/pouch cell 1638 that reaches an unstable condition will be electrically isolated from the battery system through fuse-like failure of the neck region associated with the affected tab. Thus, each individual polymer/pouch cell includes a fuse that upon an internal short disconnects the incident cell. This will disallow current to flow into the failing cell that may further worsen the cell failure and cause additional heat with possibility of propagation.

Each of the polymer/pouch cells 1658 includes structure(s)/feature(s) that define preferential region(s) of failure, e.g., as described hereinabove with reference to FIGS. 1 and 2. Thus, the polymer/pouch cells 1658 may include venting scores along an edge, a weakened area seal or a combination thereof. In this way, if pressure increases within a polymer/pouch cell 1658, the flow of vented gasses will be controlled so as to be directed by a desired path and to a desired region within case 1652. In the exemplary embodiment of FIG. 13B, the desired region for receipt of the vented gases is in proximity to vent 1666 that extends through a face of case 1652. The features and functions of vent 1666 and the other elements mounted with respect to the face of case 1652 are described herein, e.g., with reference to FIGS. 6, 9A-9C and 10.

Although the present disclosure has been described with reference to exemplary embodiments and implementations thereof, the present disclosure is not limited by or to such exemplary embodiments or implementations. Rather, the present disclosure may be embodied in other forms without departing from the spirit or essential characteristics thereof. The present embodiments are therefore to be considered in respects as illustrative and not restrictive.

1. A battery system comprising:
an enclosure defining an interior space;
a plurality of polymer/pouch cells positioned within the interior space; and
a support structure that defines regions for introduction of the polymer/pouch cells in a spaced orientation;
wherein the plurality of polymer/pouch cells each define a region of preferential failure such that gas released from one of the polymer/pouch cells is directed in a desired direction.

2. The battery system of claim 1, wherein the region of preferential failure includes one or more venting scores.

3. The battery system of claim 1, wherein the region of preferential failure includes at least one weakened seal area.

4. The battery system of claim 1, wherein the enclosure is sealed.

5. The battery system of claim 1, further comprising a vent associated with a face of the enclosure.

6. The battery system of claim 5, wherein the desired direction for gas released from one of the polymer/pouch cell is toward the vent.

7. The battery system of claim 1, wherein the internal space of the enclosure defines a shared atmosphere region.

8. The battery system of claim 7, wherein the desired direction for gas released from one of the polymer/pouch cell is toward the shared atmosphere region.

9. The battery system of claim 1, wherein the support structure is defined in part by a plurality of interleaved barrier structures.

10. The battery system of claim 5, wherein the vent is equipped with a flame arrestor.
